(19) United States
(12) Patent Application Publication
(10) Pub. No.: US 2018/0189781 A1
(43) Pub. Date: Jul. 5, 2018

(54) REAL-TIME APPROVAL AND EXECUTION OF DATA EXCHANGES BETWEEN COMPUTING SYSTEMS

(71) Applicant: The Toronto-Dominion Bank, Toronto (CA)

(72) Inventors: Stephen John McCann, Toronto (CA); Arthur Carroll Chow, Toronto (CA); Perry Aaron Jones Haldenby, Toronto (CA); Rakesh Thomas Jethwa, Toronto (CA); John Jong Suk Lee, Toronto (CA); Paul Mon-Wah Chan, Toronto (CA)

(21) Appl. No.: 15/398,824

(22) Filed: Jan. 5, 2017

(51) Int. Cl. G06Q 20/38; G06Q 20/20; G06Q 20/06

(52) U.S. Cl. CPC G06Q 20/382; G06Q 20/204; G06Q 30/0226; G06Q 20/065; G06Q 2220/00; G06Q 20/202

(57) ABSTRACT

The disclosed embodiments include computer-implemented systems and processes that perform operations that initiate, approve, and execute exchanges of data between network-connected systems, apparatuses, and devices in a computing environment. For example, a network-connected apparatus may receive, from a network-connected terminal device, data specifying an exchange of data initiated at the terminal device. The apparatus may, in some instances, identify a data type corresponding to the received data, and based on a block-chain ledger that tracks data exchanges involving the identified data type, determine an availability of the identified data type for use in the data exchange. In response to the determination, the apparatus may transmit a message confirming the availability of the identified data type to the terminal device prior to executing the data exchange in accordance with a data exchange parameter and using the identified data type.

### TECHNICAL FIELD

The disclosed embodiments generally relate to computer-implemented systems and processes that automatically initiate, approve, and execute exchanges of data between network-connected devices in a computing environment.

### BACKGROUND

Today, payment systems and related technologies continuously evolve in response to advances in payment instruments, such as the ongoing transition from physical transaction cards to digital payment instruments maintained on mobile devices and to digital currencies decoupled from an underlying fiat currency. These innovations result in additional mechanisms for submitting payment to an electronic or physical merchant, and extend beyond the capabilities of card-based point-of-sale (POS) devices disposed at merchant locations.

### SUMMARY

The disclosed embodiments include computer-implemented systems and processes that initiate, approve, and execute exchanges of data between network-connected systems, apparatus, and devices in a computing environment. In certain instances, and as described below, an apparatus may establish an availability of a particular data type for use in an initiated data exchange based on a locally accessible distributed ledger data structure, such as a publicly accessible block-chain ledger, that tracks prior completed data exchanges involving the particular data type. The apparatus may, in further instances, transmit a confirmation of the particular data type to a terminal device that initiated the data exchange, and upon transmission of the confirmation, perform operations that execute the initiated data exchange in accordance with one or more data exchange parameters and using the identified data type. By transmitting the confirmation prior to completing the particular data exchange, the disclosed embodiments may provide the confirmation of the availability of the particular data type for use in completing the initiated data exchange in real time, contemporaneously with the initiation of the data exchange, and without delay associated with the background processes that complete the initiated data exchange.

In an embodiment, an apparatus may include a storage unit storing instructions, a communications module, and at least one processor coupled to the communications module and the storage unit. The at least one processor may be configured to execute the instructions to receive, through the communications module, data from a terminal device. In some aspects, the data may be associated with a data exchange initiated at the terminal device, and the data may include a parameter that characterizes the data exchange. The at least one processor may also be configured to execute the instructions to identify a data type based on the received data, and access data corresponding to a block-chain ledger. The block-chain ledger may, for example, track prior data exchanges involving the identified data type. The at least one processor may be configured to execute the instructions to determine, based on the accessed data, an availability of the identified data type for use in the data exchange, transmit via the communications module to the terminal device, in response to the determination, a message confirming the availability of the identified data type, and perform the data exchange in accordance with the parameter and using the identified data type. In certain aspects, the message may be transmitted to the terminal device prior to the completion of the data exchange.

In additional embodiments, a terminal device may include a storage unit storing instructions, a communications module, an interface module, and at least one processor coupled to the communications module, the interface module, and the storage unit. The at least one processor may be configured to execute the instructions to receive, through the interface module, parameter data characterizing an exchange of data initiated at the terminal device, and identify a destination computing system based on properties of the initiated data exchange. In some aspects, the destination computing system may be configured to determine an availability of a data type for use in completing the initiated data exchange based on data corresponding to a block-chain ledger, and the block-chain ledger may track prior data exchanges involving the data type. The at least one processor may also be configured to execute the instructions to transmit, through the communications module, the obtained parameter data to the destination computing system, and to receive, from the destination computing system and through the communications module, a message confirming an availability of the data type for use in completing the initiated data exchange. The message may, in one aspect, be received prior to a completion of the initiated data exchange by the destination computing system, and the at least one processor may be configured to execute the instructions to display, through the interface module, interface elements representative of the received message.

Further, in certain embodiments, a system may include a terminal device, and an apparatus communicable with the terminal device across a communications network. The apparatus may, in some aspects, include a storage unit storing instructions, a communications module, and at least one processor coupled to the communications module and the storage unit. The at least one processor may be configured to execute the instructions to receive, through the communications module, data from the terminal device. The data may, in some instances, be associated with a data exchange initiated at the terminal device, and may include a parameter that characterizes the data exchange. The at least one processor may also be configured to execute the instructions to identify a data type based on the received data and access data corresponding to a block-chain ledger. The block-chain ledger may track prior data exchanges involving the identified data type. Additionally, the at least one processor may be configured to execute the instructions to determine, based on the accessed data, an availability of the identified data type for use in the data exchange, transmit via the communications module to the terminal device, in response to the determination, a message confirming the availability of the identified data type, and perform the data exchange in accordance with the data exchange parameter and using the identified data type. In one aspect, the message may be transmitted to the terminal device prior to the completion of the data exchange.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIGS. 2A and 2B are diagrams illustrating portions of an exemplary computing environment, consistent with the disclosed embodiments.

FIGS. 3 and 4 are flowcharts of exemplary processes for approving an initiated data exchange in real-time and prior to execution, in accordance with disclosed embodiments.

FIG. 5 is a flowchart of an exemplary process for executing an approved data exchange using publicly accessible block-chain ledger data structures, in accordance with the disclosed embodiments.

### DETAILED DESCRIPTION

Reference will now be made in detail to the disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the described subject matter.

This specification describes exemplary computer-implemented apparatuses, devices, and processes that, among other things, perform operations for initiating, approving, and executing exchanges of data between network-connected devices in a computing environment. In certain instances, and as described below, a computing system may establish an availability of a particular data type for use in an initiated data exchange based on locally accessible distributed ledger data structure, such as a publicly accessible block-chain ledger, that tracks prior completed data exchanges involving the particular data type. The computing system may, in further instances, transmit a confirmation of the particular data type to a terminal device that initiated the data exchange, and upon transmission of the confirmation, perform operations that complete the initiated data exchange in accordance with one or more data exchange parameters and using the identified data type. By transmitting the confirmation prior to completing the particular data exchange, the disclosed embodiments may provide the confirmation of the availability of the particular data type for use in completing the initiated data exchange in real time, contemporaneously with the initiation of the data exchange, and without delays associated with background processes that complete the initiated data exchange.

In one aspect, the initiated data exchange may facilitate an approval and an execution of a transaction initiated at a network-connected device, such as a point-of-sale (POS) terminal associated by with a merchant, by a network-connected computing system, based on a determined context of that transaction and based on one or more transaction preferences specified by a customer that participates in the initiated transaction. Additionally, in further aspects, the network-connected computer system, such as a computing system maintained by a financial institution or business entity that administers the POS terminal device, may provide an approval of that initiated transaction to the POS terminal in real-time and prior to the settlement of the initiated transaction.

The initiated transaction may, in certain instances, correspond to a purchase transaction in which the customer purchases a good or service from the merchant at an agreed-upon price (e.g., a transaction amount), and the POS terminal may be configured to receive data identifying one or more payment instruments, loyalty programs, and/or rewards programs available to the customer for use in the initiated transaction. Payment instruments consistent with the disclosed embodiments may include, but are not limited to, credit and debit card accounts held by the customer and issued by one or more financial institutions (e.g., issuers), checking or savings accounts held by the customer at one or more financial institutions, electronic funds transfers (e.g., e-transfers), and other accounts held by or available to the customer and capable of funding purchase transaction involving the user.

Payment instruments consistent with the disclosed embodiments may also include units of one or more digital currencies held by the customer in one or more corresponding accounts (e.g., units of Bitcoin™, Litecoin™, etc.), which may be used as an alternative to a fiat currency in purchase transactions involving the merchant. Transactions involving these digital-currency accounts (e.g., transfers of the customer's digital currency to other parties and/or transfers of digital currency held by the other parties to the customer) may be tracked within a distributed ledger data structure, such as a publicly accessible block-chain ledger that includes time-stamped and validated blocks representative of individual transactions or groups of transactions involving the customer's digital currency. Additionally, and as described below, the disclosed embodiments may be configured to approve an initiated transaction in real-time based on a comparison of a corresponding transaction amount with an available balance of the customer's digital currency, which may be derived from the individual blocks of the block-chain ledger.

By way of example, a payment instrument may be encoded onto a computer-readable medium, such as a magnetic stripe disposed on a surface of a credit card and/or an EMV chip embedded within a smart card, and the POS terminal may include hardware, such as a magnetic stripe reader or a chip reader, capable of interrogating the computer-readable medium and obtaining encoded data identifying the payment instrument. In other instances, a device operated by the customer, such as a smart phone or tablet computer, may execute a payment-service application that establishes and maintains a digital wallet specifying one or more payment instruments, loyalty programs, and/or rewards programs available to the customer. As described below, when the customer disposes the device in proximity to the POS terminal device, the executed payment-service application may transmit data specifying a subset of the available payment instruments, loyalty-program accounts, and/or rewards-program accounts (e.g., account numbers, expiration dates, card-security codes (CSCs), issuer identifier numbers (IINs), accountholder names, etc.) to the POS terminal across a short-range communications network, along with data that uniquely identifies the maintained digital wallet and/or the customer (e.g., a digital wallet token and/or a digital wallet address).

In certain aspects, the POS terminal device may transmit the received payment-instrument data to a computing system associated with a payment network (e.g., payment rails maintained by Visa™ or Mastercard™), along with cryptographic data identifying the POS terminal (e.g., a cryptogram generated by the payment-network computing system) and transaction data specifying parameters of the initiated transaction, such as a transaction amount, a transaction time or date, and identifiers of the purchased goods or services. In response to the received data, the payment-network computing system may perform operations that approve the initiated transaction involving the customer's payment instrument, settle the approved transaction in accordance with the transaction parameters, and provide a confirmation of the approved transaction to the POS terminal device for presentation to the customer.

The approval of the initiated transaction may, however, not occur in real time, as the payment-network computing system may exchange data identifying the customer's payment instrument and the transaction parameters with one or more computing systems maintained by a financial institution (e.g., an issuer of the customer's payment instrument), which may confirm an availability of funds sufficient to facilitate the purchase transaction. The delay in provisioning the POS terminal with the approval confirmation may, in some aspects, be compounded by the customer's use of a loyalty or rewards program in conjunction with the payment instrument, as the payment-network computing system may perform operations that not only approve and settle the initiated transaction using the underlying payment instrument, but also account for an impact of the settled transaction on the customer's loyalty and/or rewards program. Certain of the exemplary, computer-implemented processes described below, which provide a real-time approval of an initiated transaction prior to a completion of back-end settlement processes, may be implemented in addition to or as an alternate to conventional payment processes that condition the approval of an initiated transaction on a performance of back-end settlement processes, which may require communications between the various computing systems maintained by administrators of a POS network, one or more payment networks (e.g., payment rails), and/or an issuer of the payment instrument, and which may delay the approval and execution of the initiated transaction

Furthermore, while the trusted and validated characteristics of the block-chain ledger may facilitate a real-time approval of a transaction, many POS terminals and payment-network computing systems, such as those described above, may be incapable of performing operations that initiate, approve, and/or settle transactions denominated in both fiat and digital currencies. Certain of the exemplary, computer-implemented processes described below, which link together fiat- and digital-currency-based payment instruments held by a customer and facilitate a real-time approval of an initiated transaction based on the block-chain ledger, may be implemented in addition to or as an alternate to conventional, currency-specific processes implemented by payment networks to approve and settle transaction denominated in either fiat or digital currencies.

### I. Exemplary Computing Environments

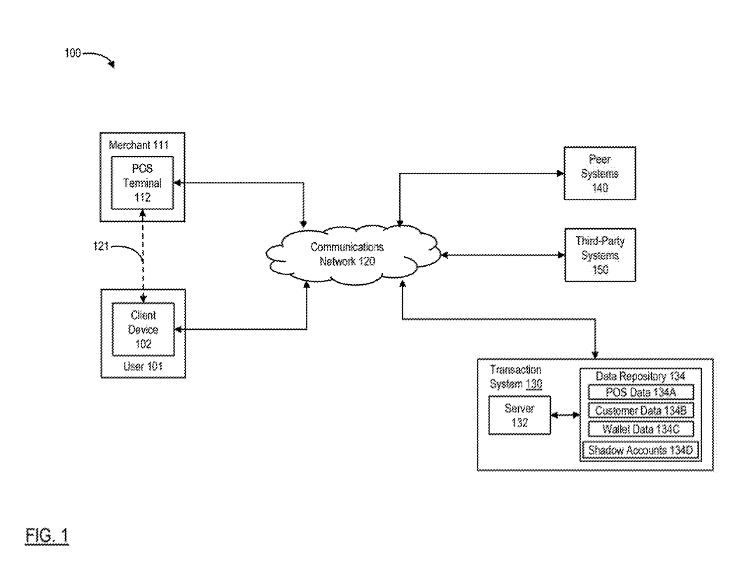

FIG. 1 is a diagram illustrating an exemplary computing environment 100, consistent with certain disclosed embodiments. In some aspects, as illustrated in FIG. 1, environment 100 may include one or more client devices, such as client device 102, one or more point-of-sale (POS) terminal devices, such a POS terminal 112, a transaction system 130, one or more peer computing systems 140, and one or more third-party computing systems 140, which may be interconnected through any appropriate combination of communications networks, such as network 120.

Examples of network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. Additionally, and some aspects, POS terminal device 102 and client device 112 may be directed connected across an short-range communications network 121, examples of which include, but are not limited to, a wireless LAN, e.g., a “Wi-Fi” network, a network utilizing RF communication protocols, a NFC network, a network utilizing optical communication protocols, e.g., infrared (IR) communications protocols, and any additional or alternate communications network, such as those described above, that facilitate peer-to-peer (P2P) communication between POS terminal device 102 and client device 112.

In an embodiment, client device 102 may be associated with a user, e.g., user 101, and may correspond to a computing device that includes one or more tangible, non-transitory memories that store data and/or software instructions, and one or more processors configured to execute the software instructions. The one or more tangible, non-transitory memories may, in some aspects, store software applications, application modules, and other elements of code executable by the one or more processors, such as a web browser, an application associated with transaction system 130 (e.g., a mobile application), and additionally or alternatively, an application associated with a payment service (e.g., a mobile application that establishes and maintains a mobile wallet), as described below.

Client device 102 may also include one or more interface modules that display information to user 101 and additionally or alternatively, that to allow user 101 to input information to client device 102 (e.g., a keypad, keyboard, touchscreen, voice activated control technologies, or any other type of known input device). Additionally, client device 102 may include a communications module, such as a wireless transceiver device, coupled to the one or more processors and configured by the one or more processors to establish and maintain communications with network 120 and network 121 using any of the communications protocols described herein.

Examples of client device 102 may include, but are not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface module, consistent with disclosed embodiments. In some instances, user 101 may operate client device 102 and may do so to cause client device 102 to perform one or more operations consistent with the disclosed embodiments.

Referring back to FIG. 1, POS terminal 112 may be associated with a merchant, e.g., merchant 111, and may correspond to a computing device that includes one or more tangible, non-transitory memories that store data and/or software instructions, and one or more processors configured to execute the software instructions. The one or more tangible, non-transitory memories may, in some aspects, store software applications, application modules, and other elements of code, which when executed by the one or more processors, cause POS terminal 112 to perform operations consistent with the disclosed embodiments, as described below.

In one aspect, POS terminal 112 may be disposed within a physical location of the merchant, such as a location where a customer, such as user 101, may provide payment for goods and/or services (e.g., at a cash register at the merchant). POS terminal 112 may, in some instances, include one or more interface modules that display information to user 101 and additionally or alternatively, that to allow user 101 to input information to POS terminal 112 (e.g., a keypad, keyboard, touchscreen, voice activated control technologies, or any other type of known input device). POS terminal 112 may also include a communications module, such as a wireless transceiver device, coupled to the one or more processors and configured by the one or more processors to establish and maintain communications with network 120 and network 121 using any of the communications protocols described herein.

By way of example, user 101 may present a physical transaction card, such as a credit card or a debit card, to POS terminal 112 as a payment for the purchase of the good or service from merchant 111. As described above, the presented transaction card may include one or more computer-readable media, such as a magnetic stripe, integrated circuit, or EMV chip, which may encode a corresponding payment instrument held by or associated with user 101. In certain aspects, POS terminal 112 may include or may be in communication with additional hardware, such as a magnetic stripe reader or a chip reader, capable of requesting and obtaining encoded data identifying the corresponding payment instrument from the computer-readable medium (e.g., by interrogating the computer-readable medium). For example, the additional hardware may be integrated into POS terminal 112, e.g., as an integrated card or chip reader, and additionally or alternatively, may correspond to an external card or chip reader connected to POS terminal 112 through a wired or wireless communication channel (e.g., a USB connection, NFC communication channels, etc.).

In other instances, and as described above, client device 102 may execute a payment-service application that establishes and maintains a digital wallet specifying payment instruments, loyalty-program accounts, and/or rewards-program accounts available to user 101. For example, user 101 may dispose client device 102 proximate to POS terminal 112, and the executed payment-service application may cause client device 102 to transmit payment data identifying one or more of the payment instruments, loyalty-program accounts, or rewards-program accounts to POS terminal 112 across network 121 using any of the communications protocols described herein. POS terminal 112 may receive the transmitted information through the communications module, and may process the payment data to perform operations consistent with the disclosed embodiments. By way of example, the payment data may include, but is not limited to, data specifying a subset of the available payment instruments, loyalty-program accounts, and/or rewards-program accounts (e.g., account numbers, expiration dates, card-security codes (CSCs), issuer identifier numbers (IINs), accountholder names, etc.) and additionally or alternatively, data that uniquely identifies the maintained digital wallet and/or the user 101 (e.g., a digital wallet token and/or a digital wallet address).

Examples of POS terminal 112 may include, but are not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations consistent with disclosed embodiments. Further, although not depicted in FIG. 1, POS terminal 112 may also be coupled to a computing system associated with and maintained by merchant 111 (e.g., a cash register, etc.), which may include one more processors and one of more tangible, non-transitory memories storing one or more software applications, application modules, and other elements of code that, when executed by the one or more processors, cause the merchant computing system to exchange data with POS terminal 112 and perform operations consistent with the disclosed embodiments.

The disclosed embodiments are not limited to such POS terminals, and in additional aspects, POS terminal 112 may correspond to one or more application modules executed by a computer system maintained by merchant 111, one or more computing systems operating within environment 100, such as transaction system 130, one or more client devices operating within environment 100, such as client device 102. In other embodiments, POS terminal 112 may represent a device communicatively coupled to client device 102 to provide mobile point-of-sale and payment services, such as a Square™ device in communication with client device 102 across network 121.

Transaction system 130 may, in some aspects, represent a computing system configured to execute software instructions (e.g., one or more executable application modules) that perform operations consistent with disclosed embodiments. For example, and as described below, transaction system 130 may perform operations that maintain and administer one or more POS devices or terminals (or executable POS modules) operating within environment 100, such as POS terminal 112, and transaction system 130 may provide, to POS terminal 112 (and to similar devices operating within environment 100), elements of executable code (e.g., application modules, etc.), POS-related cryptograms, authentication tokens, and other data that enable terminal device 112 to perform operations consistent with certain disclosed embodiments, either alone or in conjunction with transaction system 130.

In one instance, transaction system 130 may include one or more servers (e.g., server 132) and tangible, non-transitory memory devices storing executable code and application modules. Further, server 132 may include one or more processor-based computing devices, which may be configured to execute portions of the stored code or application modules to perform operations consistent with the disclosed embodiments, including operations consistent with the exemplary micropayment settlement processes described herein. In other instances, and consistent with the disclosed embodiments, transaction system 130 may correspond to a distributed system that may include computing components distributed across one or more networks, such as network 120, or other networks, such as those provided or maintained by cloud-service providers.

As illustrated in FIG. 1, transaction system 130 may maintain a data repository 134 (e.g., within one or more of the tangible, non-transitory memories) that includes POS data 134A, customer data 134B, wallet data 134C, and one or more shadow accounts 134D. In some aspects, POS data 134B may include cryptographic data (e.g., a POS cryptogram or a POS token) that uniquely identifies one or more POS devices or terminals operating within environment 100 (e.g., POS terminal 112), and transaction system 130 may perform operations that transmit the generated cryptographic data to corresponding ones of the POS terminals using any of the processes described herein. By way of example, and as described below, POS terminal 112 may receive a POS cryptogram from transaction system 130, store the received POS cryptogram within a corresponding tangible, non-transitory memory, and incorporate the stored POS cryptogram into a request to approve and/or settle an initiated transaction, which POS terminal 112 may transmit to transaction system 130 using any of the processes described herein. In certain instances, the POS cryptogram incorporated into the received transaction request may enable transaction system 130 to compare the received POS cryptogram against a stored POS cryptogram (e.g., in POS data 134A) and validate an identity of POS terminal 112 prior to approving and/or settling the initiated transaction, as described below.

Payment-instrument data 134B may, in some aspects, include data that identifies and links together one or more payment instruments, loyalty-program accounts, or rewards-program accounts held by each customer of a financial institution or business entity that maintains transaction system 130. For example, user 101 may access, through client device 102, a web page or other graphical user interface (GUI) associated with transaction system 130 (e.g., a GUI generated by a mobile application provided by transaction system 130), and may provide input to client device 102 (e.g., through the interface module) that specifies one or more authentication credentials assigned to user 101 by transaction system 130, which client device 102 may package and transmit to transaction system 130 using any of the processes described herein. In response to a successful authentication of user 101 (e.g., based on a comparison with stored authentication credentials), transaction system 130 may push additional information to client device 102 that, when presented through the web page or GUI, prompts user 101 to provide additional input identifying the one or more payment instruments, loyalty-program accounts, or rewards-program accounts.

For example, user 101 may provide input to client device 102, e.g., through the corresponding interface module, data that includes, but is not limited to, an account number, an expiration data, a card security code (CSC) number, a name or address of an account holder, and/or any additional or alternate information identifying each of the one or more payment instruments, loyalty-program accounts, or rewards-program accounts held by user 101. As described above, payment instruments consistent with the disclosed embodiments may include, but are not limited to, credit and debit card accounts held by user 101 and issued by one or more financial institutions, accounts that include units of one or more digital currencies held by user 101, checking or savings accounts held by user 101 at one or more financial institutions, electronic funds transfers, and other accounts held by or available to user 101 and capable of funding purchase transaction involving user 101, and the loyalty-program and/or rewards-program accounts may be established and administered by one or more merchants, financial institutions, or other business entities.

Client device 102 may, in some instances, perform operations that package and transmit the inputted data to transaction system 130, which may associate the received data with a customer identifier of user 101 (e.g., an alpha-numeric user name, etc.) and store the received data and associated customer identifiers within one or more structured data records of customer data 1348. In additional aspects, transaction system 130 may perform operations that link together that data identifying each of the payment instruments, loyalty-program accounts, or rewards-program accounts held by user 101 (and the corresponding structured data records within customer data 1348) to generate a mapping of the available payment instruments, loyalty-program accounts, and rewards-programs accounts held by or available to user 101. The generated mapping may, in some instances, establish combinations of payment instruments, loyalty-program accounts, and/or rewards-programs accounts capable of funding transactions involving user 101, and further, may enable transaction system 130 to identify certain combinations of loyalty and/or rewards programs that are consistent for use in transactions involving a specific payment instrument (e.g., a credit card account or a digital currency account) held by user 101.

In further aspects, and in response to the successful authentication described above, transaction system 130 may push further information to client device 102 that, when presented through the web page or GUI, prompts user 101 to input data that correlates certain payment instruments, loyalty-program accounts, and rewards-program accounts held by user 101 with corresponding combinations of user-specified contextual parameter values, which may characterize corresponding transactions in which user 101 intends or prefers to use the certain payment instruments, loyalty-program accounts, and rewards-program accounts. Client device 102 may, in certain aspects, perform operations that package and transmit the inputted data (e.g., which may establish certain transaction preferences of user 191) to transaction system 130, which may associate the inputted data with the identifier of user 101 and store the inputted data and associated customer identifier within one or more structured data records of customer data 134B.

Referring back to FIG. 1, wallet data 134C may include data that uniquely identifies a mobile wallet established on behalf of user 101 by a payment-services application executed by client device 102, such as a wallet address or a wallet token generated by the executed payment-service application. In further aspects, wallet data 134C may also identify one or more payment instruments, loyalty-program accounts, or rewards-program accounts maintained by the established mobile wallet, and additionally or alternatively, cryptographic data that facilitates an initiation and settlement of transactions involving certain ones of the maintained payment instruments. For example, the established mobile wallet may include a credit-card account, a digital-currency account, and loyalty-program account associated with a particular merchant, and wallet data 134 may include a wallet address for the established mobile wallet, data that identifies the credit-card account, a digital-currency account, and loyalty-program account, and a private cryptographic key of user 101 that facilitates an initiation of transactions involving the digital-currency account (e.g., based on a generation of new transaction blocks for inclusion within an updated block-chain ledger).

Shadow accounts 134D may include data associated with a plurality of individual shadow accounts, which may represent the payment instruments, loyalty-program accounts, or rewards-program accounts held by or associated with user 101 and additionally or alternatively, other customers of the financial institution or business entity that maintains transaction system 130 (e.g., as identified by structured data records of customer data 134B). Further, the stored shadow-account data may, in some instances, reflect a current account balance the payment instruments, loyalty-program accounts, or rewards-program accounts, and transaction system 130 may perform operations that poll one or more computing systems associated with financial institutions or business entities (e.g., third-party computing systems 150) to obtain the current account balances for the payment instruments, loyalty-program accounts, or rewards-program accounts. By way of example, transaction system 130 may, in some instances, obtain the current account balances from third-party computing systems 150 at regular or predetermined intervals, or in response to specific events, such as an initiation of a transaction involving the payment instruments, loyalty programs, and/or rewards programs.

Further, and in additional aspects, shadow accounts 134D may also include data that characterizes a current status, e.g., a current balance, of an account held by merchant 111 at the financial institution associated with transaction system 130 (e.g., which administers POS terminal 112). For example, the account may identify funds transferred from payment instruments of various customers that conduct purchase transaction with merchant 111 (e.g., as adjusted to reflect any fees imposed on merchant 111 by the financial institution for use of POS terminal 112), and the identified funds may be cleared from the account at predetermined intervals and transferred to other financial accounts held by merchant 111, such as a commercial checking account held by merchant 111 at another financial institution.

Referring back to FIG. 1, peer systems 140 may include one or more computing systems configured to execute software instructions to perform one or more operations consistent with disclosed embodiments. In some aspects, peer systems 140 may include computing components configured to store, maintain, and generate data and software instructions. For example, each of peer systems 140 may include one or more computing devices (e.g., a server, network computer, or mainframe computer) having one or more processors that may be selectively activated or reconfigured by executable instructions (e.g., computer programs) stored in one or more tangible, non-transitory computer-readable storage devices.

In an embodiment, one or more of peer systems 140 may be configured to receive, from client device 102, POS terminal 112, and/or transaction system 130 across network 120, information associated with a transaction involving units of a digital currency held by user 101 within a corresponding account and tracked within publicly accessible, block-chain ledgers consistent with the disclosed embodiments. By way of example, the received information may include, but is not limited to, a cryptographic hash of a prior transaction involving user 101's digital currency subject to the transaction, a number of units of the digital currency involved in the transaction, and a public key of the recipient of the transacted units of the digital currency (e.g., a public key of merchant 111). Further, in some instances, the received information may also include a digital signature of user 101, which may be applied the cryptographic hash and merchant 111's public key using a private key of user 101.

In certain aspects, the one or more of peer systems 140 may be configured (e.g., by the executed software programs) to validate the received information and to generate a new block of the block-chain ledger that includes the received information, either alone (e.g., using a “one transaction, one block” paradigm) or in combination with information identifying additional distributions, transactions, or other actions associated with one or more tracked assets (e.g., as a multiple-transaction block). The one or more of peer systems 140 may be further configured to generate one or more hashes representative of the new block, which may be appended to a prior version of the block-chain ledger along with the newly generated block. In some aspects, the one or more of peer system 140 may maintain the updated block-chain ledger (i.e., the latest, longest block-chain ledger), and may provide the updated block-chain ledger to client device 102, POS terminal 112, and/or transaction system 130 upon receipt of a request across network 120 and/or at regular or predetermined intervals.

In certain instances, and in addition to a connection with network 120, peer systems 140 may be interconnected across a peer-to-peer network (not depicted in FIG. 1) using any of the wired or wireless communications protocols outlined above. Further, in some instances, one or more of peer systems 140 may function as a “miner,” where any miner may be compensated in units of a virtual currency (e.g., Bitcoin™) for validating the received data and for generating updated versions of the block-chain ledger.

Further, and as illustrated in FIG. 1, third-party computing systems 150 may include one or more individual computing systems, each of which may include computing components configured to store, maintain, and generate data and software instructions. For example, each of third-party computing systems 150 may include one or more computing devices, which may be configured to execute elements of code and/or software instructions (e.g., application modules) stored in tangible, non-transitory memories. Further, in some instances, third-party computing systems 140 may be associated with or maintained by one or more financial institutions or business entities, which may include, but are not limited to, financial institutions that issue payment instruments held by user 101, a financial institution or business entity associated with transaction system 130 (and that administers POS terminal 112), and further, financial institutions or business entities that establish and administer one or more loyalty or rewards programs associated with user 101.

II. Exemplary Computer-Implemented Processes for Initiating, Approving, and Executing Real-Time Exchanges of Data between Computing Systems using Block-Chain Ledgers

In some embodiments, a network-connected device, such as POS terminal 112, may perform operations that initiate an exchange of data with a network-connected computing system, such as transaction system 130. The data exchange may, in certain aspects, enable transaction system 130 to select a payment instrument available for use in a transaction initiated at POS terminal 112 based on a determined context of the initiated transaction and based on one or more transaction preferences specified by a customer, such as user 101. In some instances, transaction system 130 may be maintained by a financial institution or business entity that administers POS terminal 112, may be configured to provide an approval of that initiated transaction to POS terminal 112 in real-time and prior to the settlement of the initiated transaction using the selected payment instrument.

In certain aspects, the initiated transaction may correspond to a purchase transaction in which user 101 purchases a good or service from a merchant, such as merchant 111, at an agreed-upon price (e.g., a transaction amount). By way of example, user 101 may elect to purchase a tennis racket from a physical location of merchant 111 for a transaction amount of $100, and POS terminal 112 may obtain transaction data that identifies the tennis racket and the transaction amount. POS terminal 112 may store the obtained transaction data within one or more tangible, non-transitory memories, and may generate and present a graphical representation of portions of the obtained transaction data to user 101 through a corresponding interface module, such as a pressure-sensitive, touchscreen display unit.

In one instance, POS terminal 112 may be coupled to a scanning device, such as a handheld or flatbed scanner, which may capture data indicative of a machine-readable code disposed on the tennis racket, such as bar code, a universal product code (UPC), or a QR code, and POS terminal 112 (and/or one or more computing systems maintained by merchant 111) may process the captured data and obtain portions of the transaction data for presentation to user 101 through the interface module. In other instances, POS terminal 112 may obtain portions of the transaction data through any additional or alternate mechanism appropriate to the purchase good or service, e.g., the tennis racket, and to POS terminal 112, such as through a manual input of portions of the transaction information through a corresponding interface unit.

Further, and in response to the presented data, user 101 may provide, to POS terminal 112, one or more forms of payment accepted by merchant 111 (and POS terminal 112) and capable or funding the purchase of the tennis racket. By way of example, user 101 may present a physical transaction card, such as a credit card or a debit card, to POS terminal 112 as the payment for the purchase of the good or service from merchant 111. The presented transaction card may, for example, include one or more computer-readable media, such as a magnetic stripe, integrated circuit, or EMV chip, which may encode a corresponding payment instrument held by or associated with user 101. As described above, POS terminal 112 may include or may be in communication with additional hardware, such as a magnetic stripe reader or a chip reader, capable of interrogating the computer-readable medium and obtaining encoded data identifying the corresponding payment instrument.

In other instances, user 101 may operate client device 102, which executes a payment-service application that establishes and maintains a digital wallet specifying payment instruments, loyalty-program accounts, and/or rewards-program accounts available to user 101. For example, to facilitate the $100 payment for the new tennis racket, user 101 may dispose client device 102 proximate to POS terminal 112, and a communications module of client device 102 may establish communications with POS terminal 112 across network 121 using any of the communications protocols described herein. In response to the established communications, the executed payment-service application may cause client device to present, to user 101 through the interface module, data that identifies one or more payment instruments, loyalty-program accounts, or rewards-program accounts maintained within the mobile wallet of user 101. The presented data may, in some instances, prompt user 101 to select a corresponding one of the payment instruments for use in the transaction with merchant 111, along with one or more of the loyalty-program accounts or rewards-program accounts.

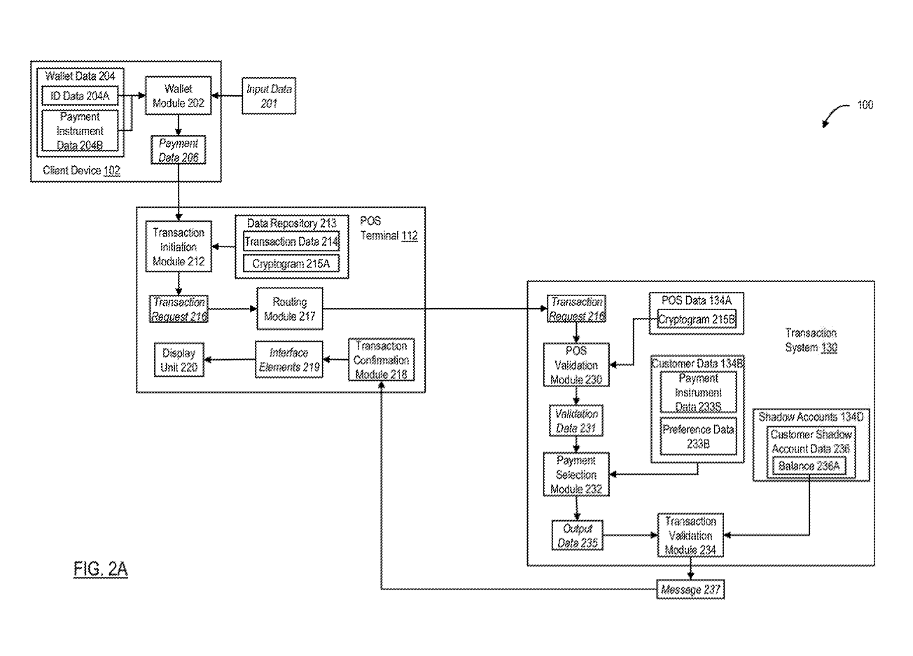

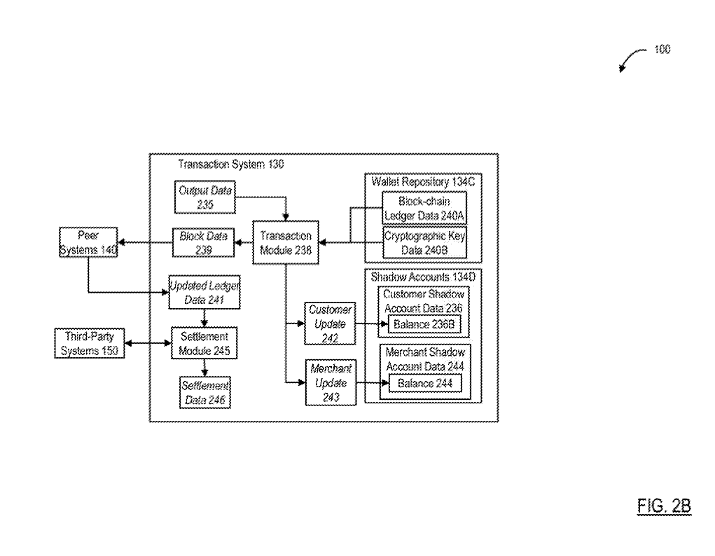

As illustrated in FIG. 2A, a mobile wallet module 202 of client device 102 may receive, through a corresponding interface module (not depicted in FIG. 2A), input data 201 that identifies a payment instrument available for use in the purchase transaction (and in some aspects, one or more of the available loyalty-program accounts or rewards-program accounts). Mobile wallet module 202 may also perform operations that access a data repository 204 (e.g., as maintained within one or more tangible, non-transitory memories), which includes identification data 204A that uniquely identifies the maintained digital wallet and/or the user 101 (e.g., a digital wallet token and/or a digital wallet address) and payment instrument data 204B that identifies the payment instruments, loyalty-program accounts, and/or rewards-program available to user 101 and maintained by the executed payment-services application within the mobile wallet.

In some aspects, mobile wallet module 202 may obtain the digital wallet token and/or the digital wallet address from identification data 204A, and may obtain a portion of payment instrument data 204B that corresponds to the identified payment instrument (e.g., an account number, expiration date, card-security code (CSC), issuer identifier number (IIN), accountholder name, etc.). Mobile wallet module 202 may perform operations package the obtained portions of identification data 204A and payment instrument data 204B into payment data 206, which client device 102 may transmit across network 121 to POS terminal 112 using any of the communications protocols outlined above.

In some aspects, a transaction initiation module 212 of POS terminal device 112 may receive payment data 206 from client device 102, and further, may access a data repository 213 maintained within one or more tangible, non-transitory memories and extract transaction data 214 and POS cryptogram 215A. By way of example, and as described above, transaction data 214 may include, among other things, data identifying the product or service associate with the transaction (e.g., a product code or description identifying the tennis racket) and one or more parameters of the transaction, such as the transaction amount of $100. Further, and as described above, POS cryptogram 215A may uniquely identify POS terminal 112 (e.g., as assigned and provided to POS terminal 112 by transaction system 112, as described above). Transaction initiation module 212 may perform operations that package payment data 206, transaction data 214, and POS cryptogram 215A into a transaction request 216, which may be provided as input to a routing module 217 of POS terminal 112.

Routing module 217 may, in certain aspects, perform operations that determine whether transaction request 216 should be routed to one or more computing systems associated with an existing payment network for transaction approval and settlement (e.g., a “payment rail” associated with a fiat currency, such as Visa™, Mastercard™, American Express™, and/or Discover™ payment networks, and/or a payment rail associated with a digital or crypto-currency, such as a Bitcoin™ rail), or alternatively, to transaction system 130 for real-time approval and subsequent settlement based on a determined transaction context and on one or more customer-specified preferences. For example, and as described above, transaction system 130 may be configured to provide, to POS terminal 112, elements of code, applications, and/or application modules that, when executed by at least one processor of POS terminal 112, cause POS terminal 112 to perform operations consistent with the disclosed embodiments. In certain aspects, and consistent with the disclosed embodiments, routing module 217 may establish the routing determination, and the destination of transaction request 216, on an election by user 101 to participate in the real-time transaction approval processes performed by transaction system 130.

For example, and as described above, user 101 may indicate the election by providing, to transaction system 130 through client device 102, transaction preference data that identifies user-specified correlations between specific payments instruments, or specific combinations of payment instruments, loyalty programs, and/or rewards programs, with corresponding contextual characteristics of initiated transactions. In one aspect, and upon receipt of the transaction preference data of user 101, transaction system 130 may generate indicator data that reflects user 101's election to participate in the real-time transaction approval processes, and may transmit the generated indicator data to POS terminal 112 for storage in a corresponding tangible, non-transitory memory. In other aspects, transaction system 130 may transmit the generated indicator data to the payment-service application executed by client device 102 (e.g., through a corresponding programmatic interface), which may incorporate the generated indicator data into the payment data transmitted to POS terminal 112. Further, in additional aspects, transaction system 130 may transmit the generated indicator data to a computer system maintained by an issuer of the physical transaction card, which may incorporate the generated indicator data into the data encoded onto the magnetic stripe, IC chip, or EMV chip, and which POS terminal 112 may receive using any of the processes described above.

Referring back to FIG. 2A, if routing module 217 were unable to detect the generated indicator data associated with user 101, routing module 217 may determine that user 101 elected not to participate in the real-time transaction approval processes performed by transaction system 130. Based on the determination, routing module 217 may perform operations that transmit, through a communications module of POS terminal 112 (not depicted in FIG. 2A), transaction request 216 to one or more computing systems associated with an existing payment network for approval and settlement (e.g., a “payment rail” associated with a fiat currency, such as Visa™ Mastercard™, American Express™, and/or Discover™ payment networks, and/or a payment rail associated with a digital or crypto-currency, such as a Bitcoin™ rail).

If, however, routing module 217 were to detect the generated indicator data associated with user 101, routing module 217 may determine that user 101 elected to participate in the real-time transaction approval processes performed by transaction system 130, and perform operations that transmit transaction request 216 transaction system 130, e.g., through the communications module of POS terminal 112. In some aspects, transaction system 130 may perform operations that approve the initiated transaction in real-time and prior to the settlement of the initiated transaction using a payment instrument selected on the basis of a determined transaction context and one or more user-specified transaction preferences, as described below

In certain aspects, a POS validation module 230 of transaction system 130 may receive transaction request 216 and perform operations that validate an identity of POS terminal 112. By way of example, example, POS validation module 230 may perform operations that parse transaction request data 216 to identify extract POS cryptogram, which POS validation module 230 may compare against a locally stored POS cryptogram 215B stored within POS data 134A. In some instances, and as described above, transaction system 130 may perform operations that assign POS cryptogram 215B to POS terminal 112 and provide POS cryptogram 215B to POS terminal 112 across one or more secured, out-of-band communications channels, and POS validation module 230 may validate the identity of POS terminal 112 based on a determined correspondence between POS cryptograms 215A and 215B.

For example, if POS validation module 230 fails to establish a correspondence between POS cryptogram 215A (e.g., as extracted from transaction request 216) and POS cryptogram 21B (e.g., as locally stored within POS data 134), POS validation module 230 may generate an error message (not depicted in FIG. 2A), which transaction system 130 may transmit to POS terminal 112 across network 120. If, however, POS validation module 230 were to establish that POS cryptogram 215A corresponds to POS cryptogram 215B, POS validation module 230 may validate the identity of POS terminal 122, and may process transaction request 216 to extract digital-wallet data that uniquely identifies the digital wallet established and maintained by the payment-service application executed by client device 102 (e.g., the digital wallet token and/or the digital wallet address), merchant data that identifies the merchant, and further, and the one or more transaction parameters that characterize the initiated transaction (e.g., data that identifies the tennis racket and the transaction amount). In some instances, POS validation module 230 may package the digital-wallet data, the merchant data, and the transaction parameters into validation data 231, which POS validation module 230 may provide as an input to a payment selection module 232 of transaction system 130.

In certain aspects, payment selection module 232 may perform operations that process the digital-wallet data, the merchant data, and the transaction parameters included within validation data 231 to determine values of one or more contextual parameters that collectively establish a context of the initiated transaction. By way of example, the determined contextual parameter values may include, but are not limited to, values of one or more characteristics of a product or service involved in the initiated transaction (e.g., a manufacturer or model number of the tennis racket involved in the initiated transaction), a name or location of a merchant involved in the initiated transaction (e.g., a name of merchant 111 and/or merchant 111's location), and one or more of the transaction parameters (e.g., a date and time of the initiated transaction or a transaction amount). The disclosed embodiments are, however, not limited to these examples of contextual parameters and contextual parameter values, and in additional aspects, payment selection module 232 may perform operations that determine values of any additional or alternate contextual parameter that characterizes the initiated transaction and, when taken collectively, establish the context of the initiated transaction.

By way of example, and as described above, the initiated transaction may correspond to a purchase of a new tennis racket (e.g., a model Ti.S6 tennis racket manufactured by Head BV) in the amount of $100 from a membership-based warehouse club (e.g., Costco™) located in Arlington, Va., on Jan. 15, 2016, at 3:45 p.m. In some instances, and based on portions of validation data 231, payment selection module 232 may perform operations to determine values of contextual parameters of the initiated transaction that include, but are not limited to, a product type (e.g., the tennis racket), a product model (e.g., the Ti.S6 model), a product manufacturer (e.g., Head BV), a transaction amount (e.g., $100), and transaction date and time (e.g., Jan. 15, 2016, at 3:45 p.m.), a merchant type (e.g., a warehouse club), a merchant name (e.g., Costco™), and a merchant location (e.g., Arlington, Va.). When taken collectively, the determined values may establish a context of the initiated transaction, and in certain instances, the one or more transaction preferences specified by user 101 may correlate specific payment instruments, rewards-program accounts, and/or loyalty-program accounts with user-specified combinations of the contextual parameters and corresponding user-specified values of these contextual parameters.

Referring back to FIG. 2A, payment selection module 232 may access stored customer data 134B (e.g., as maintained within one or more tangible, non-transitory memories) and may extract preference data 233B that include the one or more transaction preferences specified by user 101. As described above, the one or more transaction preferences may correlate certain payment instruments, loyalty-program accounts, and rewards-program accounts held by user 101 with corresponding combinations of user-specified contextual parameter values, which may characterize corresponding transactions in which user 101 intends or prefers to use the certain payment instruments, loyalty-program accounts, and rewards-program accounts.

For example, and as described above, user 101 may hold payment instruments that include, but are not limited to, a MasterCard™ credit card, a Visa™ debit card, a checking account and a line-of-credit held at a financial institution, and a an account that holds units of a digital currency, such as Bitcoin™ or Litecoin™. Additionally, user 101 may also hold a rewards-program account that accrues points redeemable at one or more partner merchants (e.g., a Plenti™ account), and a loyalty-program account associated with the membership-based warehouse club (e.g., Costco™). In some instances, transaction system 130 may store data that identifies and links together the available payment instruments, loyalty-program accounts, and rewards-program accounts within a portion of one or more tangible, non-transitory memories, such as within payment instrument data 233A of customer data 134B, and as described above, transaction system 130 may be configured to establish and maintain a shadow account for user 101 that tracks, among other things, a current account balance associated with each of the available payment instruments, loyalty-program accounts, and rewards-program accounts held by user 101.

In some instances, preference data 233B may specify, for one or more of the available payment instruments, loyalty-program accounts, and rewards-program accounts, corresponding combinations of contextual parameter values that characterize transactions in which user 101 intends or prefers to use these payment instruments, loyalty-program accounts, and rewards-program accounts. For example, preference data 233B may specify that user 101 prefers to utilize the MasterCard™ credit card for any purchase transaction involving a transaction amount between $50 and $1000, and any physical or electronic merchant except the membership-based warehouse club (which, for example, may not accept payments processed through a MasterCard™ payment network).

Additionally or alternatively, preference data 233B may also specify that the Visa™ debit card be used for any purchase transaction involving any physical or electronic merchant, characterized by a transaction amount of $50 or less, and occurring between the first day of a corresponding month and the twenty-first day of that corresponding month (e.g., to ensure a linked financial-services account of the user is not depleted prior to a second monthly paycheck). In other instances, preference data 233B may specify the digital-currency account (e.g., holding units of Bitcoin™) be used for any purchase transaction involving the membership-based warehouse club and characterized by a transaction amount in excess of $50 and further, for any purchase transaction characterized by a transaction amount in excess of $1,000.

Preference data 233B may also specify user 101's preference that the rewards-program account (e.g., the Plenti™ account) be used in conjunction with any payment instrument for purchase transactions not involving the membership-based warehouse club, and further, that the loyalty-program account be used in conjunction with any payment instrument for purchase transaction involving the membership-based warehouse club. Additionally, and as described above, preference data 233B may specify a default payment instrument, such as a savings account maintained by a corresponding financial institution, for use in transactions when other specified payment instruments are unavailable (e.g., holding funds insufficient for a particular purchase transaction, etc.). The disclosed embodiments are, however, not limited to these examples of transaction preferences, and in further aspects, preference data 233B may correlate any available payment instrument, rewards-program account, or loyalty-program account to any additional or alternate combination of contextual parameter values that would be appropriate to the payment instruments, rewards-program accounts, and/or loyalty-program accounts, and to the initiated transaction.

Referring back to FIG. 2A, payment selection module 232 may perform operations for selecting a payment instrument that is available for use in the initiated payment transaction and further, associated with user-specified transaction preferences that are consistent with the determined context of the initiated transaction. For example, the context of the initiated transaction may be established by contextual parameter values that include, but are not limited to, a product type (e.g., the tennis racket), a transaction amount (e.g., $100), a transaction date and time (e.g., Jan. 15, 2016, at 3:45 p.m.), and a merchant type (e.g., a warehouse club). Based on a comparison of portions of preference data 233B and the contextual parameter values that characterize the initiated transaction, payment selection module 232 may select the digital-currency account held by user 101 as the payment instrument for the initiated transaction involving the Head™ tennis racket, the transaction amount of $100, and the membership-based warehouse club, and may further determine that the loyalty-program account should be using in conjunction with the digital-currency account when settling the initiated transaction.

Payment selection module 232 may in some aspects, generate output data 235 that includes, but is not limited to, data specifying the selected digital-currency account and loyalty-program account (e.g., account numbers, expiration dates, accountholder names), and data specifying the one or more transaction parameters, such as the merchant name or POS identifier (e.g., Costco™ or the POS cryptogram), the transaction amount (e.g., $100), and the transaction data and time (e.g., Jan. 15, 2016, at 3:45 p.m.). Payment selection module 232 may provide output data 215 to a transaction validation module 234 of transaction system 130, which as described below, may perform operations that approve the selected digital-currency account for use in the initiated transaction in real-time and prior to a settlement of the initiated transaction using the selected digital-currency and loyalty-program accounts.

In one aspect, transaction validation module 234 may receive output data 235, and may perform operations that establish whether selected payment instrument, e.g., the digital-currency account of user 101, supports processes that approve the initiated transaction in real-time and prior to settlement. For instance, as an accessible and peer-validated block-chain ledger data structure tracks the units of digital currency held by user 101 and available for transfer to other parties (e.g., which represents the current balance of the digital-currency account), a digital-currency account held by user 101 would support real-time approval using any of the processes described herein. Alternatively, a credit or debit card may not support a real-time approval for use in the initiated payment transaction, as such a decision may require communication between transaction system 130 and one or more payment rails (e.g., a computing system maintained by a Visa™ payment network) of computing systems maintained by corresponding issuers.

For example, and as described above, the selected payment instrument may correspond to the digital-currency account of user 101, which may hold units of a digital currency (such as Bitcoin™ or Litecoin™). In some aspects, transaction validation module 234 may that the digital-currency account of user 101 supports the real-time approval of the initiated transaction prior to settlement, and may perform operations that determine a current account balance of the selected digital-currency account (e.g., a number of units of digital currency held by user 101) and validate the availability of the selected digital-currency account for use in the initiated transaction based on comparison of the current account balance and the transaction amount.

In one instance, transaction validation module 234 may access stored data identifying a shadow account representative of the selected digital-currency account of user 101 (e.g., customer shadow account data 236 of stored shadow accounts 134D), which may be established and maintained by transaction system 130 based on a current block-chain ledger that tracks the units of digital currency held by user 101. For example, and as described above, transaction system 130 may be configured to obtain (e.g., from one or more of peer systems 130 at regular intervals) data corresponding to the current block-chain ledger, and transaction system 130 may be configured to validate a digital signature of user 101 applied to ledger blocks associated with user 101's digital-currency account (e.g., using a public cryptographic key assigned to user 101). Transaction system 130 may further process the ledger blocks to determine a current account balance of the digital-currency account, which reflects a number of units of digital currency current held by user 101, and to store data indicative of the current account balance of the digital currency account within shadow account data 236. In some instances, transaction validation module 234 may access customer shadow account data 236, and may perform operations that extract data 236A representative of the current account balance of the digital-currency account of user 101 from access shadow account data 236.

Transaction validation module 234 may, in some aspects, perform operations that compare the current account balance of the digital-currency account of user 101 against the transaction amount associated with the initiated transaction (e.g., $100), and approve the use of the digital-currency account of user 101 in the initiated transaction when the current balance of that digital-currency account exceeds the transaction amount of the initiated transaction. For example, transaction validation module 234 may establish that user 101's digital-currency account includes units of digital currency equivalent to $1,375, and thus, determine that the current account balance of that digital currency account is sufficient to cover the transaction amount of the initiated transaction.

Based on the determined sufficiency of the current account balance of the digital-currency account, transaction validation system 234 may approve the initiated transaction in real-time and prior to settlement, and may generate a corresponding message 237 that confirms the approved transaction, which transaction system 130 may transmit across network 120 to POS terminal 112 using any of the communications protocols described herein. In certain aspects, a transaction confirmation module 218 of POS terminal 112 may receive message 237, and may perform operations to generate one or more interface elements (e.g., interface elements 219) that provide a graphical representation of the real-time approval of the initiated transaction involving the digital-currency account. A display unit 220 of POS terminal 112, such as a pressure-sensitive touchscreen display, may receive and render interface elements 119 for presentation to user 101 within a corresponding graphical user interface (GUI).

In other instances, however, transaction validation module 234 may establish that user 101's digital-currency account includes units of digital currency insufficient to cover the $100 transaction amount of the initiated transaction, and based on the determined insufficiency of the current account balance of the digital-currency account, transaction validation module 234 may decline the use of digital-currency account in the initiated transaction. In some aspects, and in response to the declined transaction, payment selection module 232 and/or transaction validation module 234 perform any of the exemplary processes described herein to select a secondary payment instrument consistent with the user-specified transaction preferences and the determined transaction context, and approve the use of that secondary payment instrument in the initiated transaction. Additionally, and in other aspects, transaction validation module 234 may perform operations that generate an error message indicative of the declined purchase transaction and transmit the generated error message to POS terminal 112, which may present the transmitted error message to user 101 through display unit 220.

In certain embodiments, transaction system 130 may select a payment instrument that is available for use in a transaction initiated at POS terminal 112 and further, that is associated with user-specified preferences that are consistent with a determined context of the initiated transaction. Further, transaction system 130 may approve the use of the selected payment instrument in the initiated transaction, and thus, approve the initiated transaction in real-time and prior to a settlement of the initiated transaction. In additional embodiments, and in response the approval of the initiated transaction, transaction system 130 may perform operations that settle the initiated transaction between user 101 and merchant 111 in accordance with the agreed-upon transaction parameters and consistent with the selected payment instrument, such as the digital-currency account of user 101 described above.

Referring to FIG. 2B, and in response to the approval of the initiated transaction, a transaction module 238 of transaction system may receive output data 235, and may perform operations that generate block data 239 specifying the transaction involving the digital-currency account of user 101, which transaction system 130 may transmit to one or more of peer systems 160 for processing, validation, and inclusion within a latest, longest block-chain ledger. As described above, output data 235 may include, but is not limited to, data specifying the selected digital-currency account and loyalty-program account (e.g., account numbers, expiration dates, accountholder names), and data specifying the one or more transaction parameters, such as the merchant name or POS identifier (e.g., Costco™ or the POS cryptogram), the transaction amount (e.g., $100), and the transaction data and time (e.g., Jan. 15, 2016, at 3:45 p.m.). Further, and as described below, block data 239 may facilitate a transfer of units of digital currency corresponding to the transaction amount from the digital-currency account held by user 101 to a corresponding account held by merchant 111.

In one aspect, and upon receipt of output data 235, transaction module 238 may access wallet repository 134C of data repository 134 (e.g., as maintained within one or more tangible, non-transitory memories), and extract block-chain ledger data 240A and cryptographic key data 240B linked to, among other things, the wallet token and/or wallet address received from POS terminal 112. By way of example, block-chain ledger data 240A may correspond to a current block-chain ledger that tracks one or more transactions involving the digital-currency account of user 101, and that transaction system 130 may receive from one or more of peer systems 130 at certain intervals. Further, and in some instances, cryptographic key data 240B may include one or more cryptographic keys associated with user 101 and merchant 111, such as a public key of merchant 111 and a private key of user 101, which transaction module 238 may process to generate portions of block data 239, as described below.

Transaction module 238 may, in certain aspects, perform operations that generate block data 239 based on portions of output data 235, block-chain ledger 240A, and cryptographic key data 240B. For example, transaction module 238 may parse block-chain ledger 240A to identify, and extract, data corresponding to a cryptographic hash applied to a ledger block describing an immediately prior transaction involving the units of digital currency held by user 101. Further, transaction module 238 may also parse cryptographic key data 240B to identify, and extract, the public key of merchant 111 and a private key of user 101. In certain aspects, the public key of merchant 111 may be included within various ledger blocks of the current or prior block-chain ledgers, and transaction system 130 may extract the public key of merchant 111 from the prior block-chain ledgers and store the extracted public key within a portion of cryptographic key data 240B. In further aspects, user 101 may provide, via client device 102, data specifying the private key to transaction system 130 during an initial registration and configuration process, as described above, and transaction system 130 may store the private key within a corresponding portion of cryptographic key data 240B.

Additionally, transaction module 238 may perform operations that generate and apply a digital signature of user 101 to the extracted cryptographic hash data and to the public key of merchant 111 (e.g., the recipient of the transferred units of digital currency). The digital signature may be generated and applied using the private key of user 101 and through any of a number of cryptographic techniques apparent to one of ordinary skill in the art and appropriate to the architecture of the block-chain ledger. In some aspects, transaction module 238 may incorporate the extracted cryptographic hash data, a number of units of digital currency subject to transfer from user 101 to merchant 111 (e.g., digital-currency units consistent with the $100 transaction amount), the public key of merchant 111, and the data corresponding to the generated digital signature of user 101 into block data 239, which transaction system 130 may transmit across network 120 to one or more of peer systems 140 using any of the communications protocols described herein.

As described above, the one or more of peer systems 140 may receive block data 239 from transaction system 130. In certain aspects, the one or more of peer systems 140 may act bas “miners” for the block-chain ledger, and may competitively process block data 239 (either alone or in conjunction with other data) to generate a new block for the block-chain ledger that reflects a transfer of the units of digital currency consistent with the $100 transaction amount from the digital-currency account of user 101 to the digital-currency account of merchant 111. The one or more of peer systems 140 may append the new block to the current block-chain ledger to establish an updated block-chain ledger, which may be distributed across peer systems 140 (e.g., through a peer-to-peer network) and to other network-connected devices operating within environment 100, such as transaction system 130. For example, transaction system 130 may receive updated ledger data 241 that corresponds to the updated block-chain ledger, which transfer of the units of digital currency consistent with between the digital-currency accounts of user 101 and merchant 111 at predetermined time or in response to a specified event.

In some aspects, transaction module 238 may perform additional operations that update portions of stored shadow accounts 134D to reflect the transfer of the units of digital currency consistent with the $100 transaction amount from the digital-currency account of user 101 to the digital-currency account of merchant 111. For example, transaction module 238 may perform operations that generate a customer update 242 that reflect a debit of the transferred units of digital currency and further, a merchant update 243 that reflects a credit of the transferred units of digital currency. Transaction module 238 may, in some instances, access data corresponding to the shadow accounts of user 101, e.g., customer shadow account data 236, and establish an updated balance 236B of the shadow digital-currency account of user 101 that reflects the debit of the transferred units of digital currency. Similarly, transaction module 238 may access data corresponding to the shadow accounts of merchant 111, e.g., merchant shadow account data 244, and establish an updated account balance 244 of the shadow digital-currency account of merchant 111 that reflects the credit of the transferred units of digital currency. In certain embodiments, by modifying balances of shadow accounts representative of the units of digital currency held within digital-currency accounts of user 101 and merchant 111, transaction system 130 may track internally the impact of the purchase transaction on the digital-currency accounts of user 101 and merchant 111 prior to, and independent of, settlement processing, which may provide an independent mechanism for auditing and reconciling an outcome of the settlement processing on the digital-currency accounts of user 101 and merchant 111.

Referring back to FIG. 2B, a settlement module 245 of transaction system 130 may receive updated ledger data 241, which corresponds to the updated block-chain ledger, and may perform operations that process and settle the initiated transaction in accordance with the selected payment instrument (e.g., the digital-currency account held by user 101), the selected loyalty-program account (e.g., the loyalty-program account associated with the membership-based warehouse club), and the transaction parameters of the initiated transaction. For example, settlement module 245 may exchange data with one or more third-party computing systems (e.g., third-party computing systems 150) maintained by the membership-based warehouse club or any additional or alternate provider of the loyalty-program account), and the one or more third-party computing systems may perform operations that credit the loyalty-program account held by user 101 in accordance with the $100 purchase of the Head™ tennis racket from the membership-based warehouse club.

Upon successful settlement of the initiated payment transaction, settlement module 245 may generate data indicative of the settlement, e.g., settlement data 246, which may be stored within one or more tangible, non-transitory memories, such as data repository 134. In some aspects, not depicted in FIG. 2B, transaction module 238 may access settlement data 246 and may modify a balance of an additional shadow account representative of the loyalty-program account of user 101 (e.g., as stored within customer shadow account data 236) to reflect the accrual of points due to user 101's purchase of the Head™ tennis racket from the membership-based warehouse club.

In certain disclosed embodiments, transaction system 130 may select an available payment instrument (e.g., the digital-currency account of user 101) for use in an initiated transaction based on a determined context of the initiated transaction and further, one or more transaction preferences specified by user 101. Additionally, transaction system 130 may also perform any of the processes described herein to approve the selected payment instrument for use in the initiated transaction, and thus, approve the initiated transaction in real-time, and provide a confirmation of the approved transaction to a corresponding point-of-sale (POS) terminal or device, such as POS terminal 112, prior to settling the initiated transaction. For example, the selected payment instrument may correspond to units of a digital currency held by user 101 within a corresponding account (e.g., units of Bitcoin™), and transaction system 130 may approve the initiated transaction based on a publicly available and peer-validated block-chain ledger that tracks transactions involving the units of the digital currency held by user 101.

In other aspects, the selected payment instrument may not support processes that approve the initiated transaction in real-time and prior to settlement. For example, and as described above, the initiated transaction may correspond to a purchase of a Head™ tennis racket from Costco™ for the amount of $100, and consistent with a determined context of the initiated transaction and user 101's transaction preferences, transaction system 130 may select, for use in the initiated transaction, a MasterCard™ credit card that receives double rewards points when used in purchase transactions involving Costco™. In certain aspects, however, transaction system 130 may be incapable of approving the MasterCard™ credit card for use in the initiated transaction in real time based on locally stored data, and instead may transmit an approval request to one or more computing systems maintained by a corresponding payment network (e.g., a MasterCard™ payment rail), which may provide a delayed response to the approval request after additional data exchanges within a computer system maintained by an issuer of the MasterCard™ credit card.

In an embodiment, and based on a determination that the selected payment instrument (e.g., a “primary” payment instrument) does not support real-time approval processing, transaction system 130 may select a secondary payment instrument held by user 101 that supports real-time approval processing, secure the transaction amount against a shadow account associated with secondary payment instrument, and approve the initiated transaction in real-time based on the secured portion of the shadow account prior to settlement processing involving the primary payment instrument. In some aspects, and in response to a successful settlement of the initiated transaction using the primary payment instrument, transaction system 130 may perform operations that release the secured potion of the shadow account associated with the secondary payment instrument, and update the shadow accounts associated with the primary payment instrument and merchant 111 to reflect the settled purchase transaction.

For example, and referring back to FIG. 2A, payment selection module 232 of transaction system 232 may perform any of the processes described herein to select the MasterCard™ credit card as a primary payment instrument for use in the initiated transaction, e.g., based on a determined context of the initiated transaction and user 101's transaction preferences. As described above, payment selection module 232 may transmit output data (e.g., output data 235) that identifies the primary payment instrument (e.g., the MasterCard™ credit card) and the transaction parameters to transaction validation module 240, which may perform any of the processes described herein to determine whether the primary payment instrument supports real-time approval processing.

In certain instances, transaction validation module 240 may determine that the primary payment instrument, e.g., the MasterCard™ credit card, does not support real-time approval processing, and in response to the determination, transaction validation module 240 and/or payment selection module 232 (or other application modules executed by transaction system 130 or server 132) may perform any of the processes described herein to select a secondary payment instrument that supports real-time approval processing, such as the digital-currency account of user 101 (not depicted in FIG. 2A). Transaction validation module 234 may receive data identifying the secondary payment instrument, and may perform any of the processes described herein to approve the secondary payment instrument for use in the initiated transaction in real-time, and transaction system 130 may transmit a message confirming the approved transaction (e.g., message 237) to POS terminal 112, may generate and present interface elements representing the approved transactions within display unit 220.

Further, in some aspects, transaction module 238 (or other application modules) of transaction system 130 may access the shadow account that represents the digital-currency account of user 101 (e.g., as stored within customer shadow account data 236 of FIG. 2B) and secure a portion of held units of digital currency that corresponds to the $100 transaction amount of the initiated transaction. Additionally, and in response to the real-time approval of the initiated transaction involving on the secondary payment instrument, settlement module 245 may perform any of the processes described herein to settle the initiated transaction using the primary payment instrument (e.g., the Mastercard™ credit card) and in accordance with the transaction parameters of the initiated transaction, which may include, but are not limited, processes that transmit settlement requests to one or more computer systems (e.g., third-party computing systems 150) maintained by appropriate payment networks, such as a Mastercard™ payment network.

In response to a successful settlement, transaction module 238 (or other application modules executed by transaction system 130) may release the secured portions of user 101's digital currency account (e.g., as secured within customer shadow account data 236 of FIG. 2B), and may update stored shadow accounts 134D to reflect the funding of the $100 purchase of the Head™ tennis racket from Costco™ using the MasterCard™ credit card held by user 101. Alternatively, and in response to an unsuccessful settlement, transaction module 238 and settlement module 245 may perform any of the processes described herein to generate an updated block-chain ledger reflecting a transfer of units of digital currency corresponding to the $100 transaction amount from user 101 to merchant 111, and to settle the initiated transaction upon receipt of the updated block-chain ledger.

In certain embodiments, described above, a payment selection module 232 of transaction system 130 may select an available payment instrument for use in an initiated transaction based on, among other things, a determined context of the initiated transaction and data specifying one or more locally stored transaction preferences of user 101 (e.g., as stored within customer data 134B). In other aspects, and consistent with the disclosed embodiments, POS terminal 112 may receive input from user 101, e.g., through the corresponding interface module, that specifies one or more of the transaction preferences described above, which POS terminal 112 may package into transaction request 216 and provide to transaction system 130 using any of the processes described above,. For example, POS terminal 112 may obtain data identifying one or more available payment instruments, rewards-program accounts, or loyalty-program accounts available for use in the initiated transaction (e.g., from the payment-services application executed by client device 112 or from transaction system 130), and POS terminal 112 may present interface elements representing the available payment instruments, rewards-program accounts, or loyalty-program accounts within a corresponding graphical user interface (GUI), which may enable user 101 to provide input, through the interface unit, that correlates the payment instruments, rewards-program accounts, or loyalty-program accounts with values of contextual parameters or combinations of contextual parameters, as described above.

Further, in certain embodiments, a routing module of POS terminal 112 may perform operations that route transaction request 216 to an appropriate destination computing system for transaction approval and settlement based on a detected indicator of user 101's election to participate in the real-time transaction approval processes provided by transaction system 130. In other aspects, and consistent with the disclosed embodiments, routing module 217 may perform operations that route transaction request 216 to transaction system 130 (e.g., for real-time transaction approval prior to settlement using payment instruments selected based on the determined transaction context and specified transaction preferences) based on a detection of one or more events.

For example, user 101 may hold one or more credit cards, debit cards, or other payment instruments issued by financial institutions that approve and settle transactions using a fiat currency, such as U.S. dollars. In some aspects, if user 101 travelled to Japan, any purchases made using these one or more credit cards, debit cards, or other payment instruments would be denominated in a different fiat currency, such as Japanese yen, and would be subject to a currency conversion prior to approval and settlement. In certain aspects, the conversion between fiat currencies during the settlement process may delay a final settlement of any initiated transaction by a significant time period, such as four to ten days.

In some aspects, POS terminal 112 may, upon receipt of payment data (e.g., based on encoded payment data obtained from a physical transaction card or mobile wallet data obtained from a payment-services application executed by client device 102), detect a mismatch between a currency associated with the payment instruments of user 101 and a fiat currency associated with POS terminal 112. In response to the detected mismatch, routing module 217 may automatically route transaction request 216 to transaction system 130, which may perform any of the exemplary processes described above to select, as a payment instrument for the initiated transaction, units of digital currency held by user 101 in a corresponding account, to approve the initiated transaction in real-time based on a publicly accessible, block-chain ledger that tracks prior transactions involving the digital currency, and that settles the initiated transaction based on a generation of an updated block-chain ledger that confirms the transfer of a portion of the units of digital currency from the account of user 101 to an account of a corresponding merchant. By using the available digital-currency account as an intermediary, the disclosed embodiments may avoid settlement delays characteristic of many cross-currency purchase transactions.

Further, in certain embodiments described above, transaction system 130 may be configured to approve in real-time and settle a transaction initiated at a network-connected device, such as POS terminal 112 associated by with a merchant, between a customer, such as user 101, and that merchant, e.g., merchant 111. In other aspects, and consistent with the disclosed embodiments, client device 102 may perform operations that initiate a person-to-person (P2P) transaction to purchase a product or service from another user of an additional client device operating within environment 100, and that transmit data to transaction system 130 that facilitates a real-time approval and settlement of the P2P transaction based on a determined context of that transaction and based on one or more transaction preferences. For example, POS terminal 112 may be implemented as an application module executed by client device 102, and transaction system 130 may perform any of the exemplary processes described above to approve the P2P transaction in real-time using a payment instrument selected on the basis of a determined context of that P2P transaction and based on one or more transaction preferences specified by user 101 (e.g., a digital-currency account of user 101), and that settle the initiated P2P transaction by updating shadow accounts maintained on behalf of user 101 and the additional user and by updating block-chain ledger to reflect the P2P transaction.

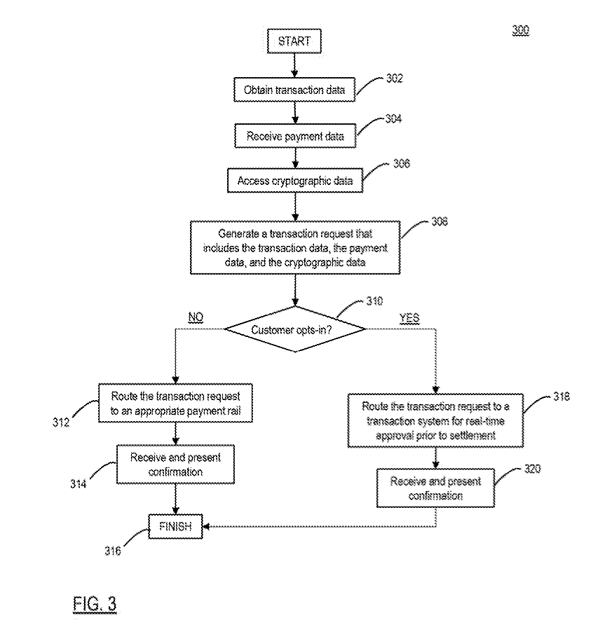

FIG. 3 is a flowchart of an example process 300 for automatically approving an initiated data exchange in real-time and prior to execution, in accordance with the disclosed embodiments. In some aspects, a point-of-sale terminal or device, such as POS terminal 112, may perform the steps of example process 300. In some instances, POS terminal 112 may be disposed within physical location of a corresponding merchant, e.g., merchant 111 of FIG. 1, and may perform operations that initiate a transaction corresponding to a purchase of a product or service from merchant 111 by a customer, e.g., user 101 of FIG. 1. For example, and as described above, POS terminal 112 may receive transaction data characterizing the product or service, and further, may receive payment data identifying a payment instrument usable to fund the initiated transaction, along with one or more rewards-program accounts or loyalty-program accounts usable in conjunction with the identified payment instrument. POS terminal 112 may generate a request data that includes portions of the transaction data, portions of the payment data, and cryptographic data that uniquely identifies POS terminal 112, such as a POS cryptogram.

POS terminal 112 may perform operations that, among other things, selectively route the generated request data to one or more computer systems capable of approving and settling the initiated transaction. In one aspect, described below, POS terminal 112 may route the generated request data to a computing system associated with a financial institution that maintains POS terminal 112, e.g., transaction system 130 of FIG. 1, and transaction system 130 may perform operations that approve the initiated transaction in real-time and prior to the settlement of the initiated transaction using a payment instrument selected on the basis of a determined transaction context and one or more user-specified transaction preferences.

Referring to FIG. 3, POS terminal 112 may obtain transaction data characterizing the initiated transaction (e.g., in step 302). By way of example, and as described above, the initiated transaction may correspond to a purchase transaction in which user 101 purchases a product or service from merchant 111, at an agreed-upon price (e.g., a transaction amount). In some aspects, the received transaction data may include, but is not limited to, the transaction amount and data identifying the purchased product or service, and POS terminal 112 may receive portions of the transaction data through any of the exemplary processes described above, such as through a connected scanning device, from a computing system in communication with POS terminal 112, or through manual input of data through a corresponding interface module associated with POS terminal 112, such as a pressure-sensitive, touchscreen display. POS terminal 112 may, in some aspects, store portions of the received transaction data within one or more tangible, non-transitory memories, and render portions of the received transaction data for presentation to user 101 through the corresponding interface module.

POS terminal 112 may also receive payment data identifying one or more payment instruments, rewards-program accounts, or loyalty-program accounts held by user 101 and intended for use in the initiated transaction (e.g., in step 304). In one aspect, and as described above, user 101 may present a physical transaction card, such as a credit card or a debit card, to POS terminal 112 as the payment for the purchase of the good or service from merchant 111. The presented transaction card may, for example, include one or more computer-readable media, such as a magnetic stripe, integrated circuit, or EMV chip, which may encode a corresponding payment instrument held by or associated with user 101. As described above, POS terminal 112 may include or may be in communication with additional hardware, such as a magnetic stripe reader or a chip reader, capable of interrogating the computer-readable medium and obtaining encoded payment data identifying the corresponding payment instrument in step 304, which POS terminal 112 may store in one or more tangible, non-transitory memories.

In other instances, user 101 may operate device, such as client device 102 of FIG. 1, which executes a payment-service application that establishes and maintains a digital wallet specifying payment instruments, loyalty programs, and/or rewards programs available to user 101. For example, to fund the initiated transaction, user 101 may dispose client device 102 proximate to POS terminal 112, and client device 102 may establish communications with POS terminal 112 across a corresponding network, such as network 121 of FIG. 1. Using any of the processes described above, client device 102 may transmit payment data to POS terminal 112 that identifies the maintained digital wallet and/or the user 101 (e.g., a digital wallet token and/or a digital wallet address) and further, the one or more payment instruments, loyalty programs, and/or rewards programs available for use in the initiated transaction. POS terminal 112 may receive the transmitted payment data in step 304, and store portions of the payment data in one or more tangible, non-transitory memories.

POS terminal 112 may, in some instances, access stored cryptographic data that uniquely identifies POS terminal 112, such as a POS cryptogram assigned and provided to POS terminal 112 by transaction system 130, as described above (e.g., in step 306), and may generate a transaction request that includes the POS cryptogram and portions of the received transaction and payment data (e.g., in step 308). Further, and based on portions of the received payment, POS terminal 112 may determine whether user 101 elected to participate in the real-time transaction approval processes performed by transaction system 130 (e.g., in step 310).

In some aspects, the determination in step 310 may be based on an election by user 101 to participate in the real-time transaction approval processes performed by transaction system 130. For example, and as described above, user 101 may indicate the election by providing, to transaction system 130 through client device 102, transaction preference data that identifies user-specified correlations between specific payments instruments, or specific combinations of payment instruments, loyalty programs, and/or rewards programs, with corresponding contextual characteristics of initiated transactions. In one aspect, and upon receipt of the transaction preference data of user 101, transaction system 130 may generate indicator data that reflects user 101's election to participate in the real-time transaction approval processes, and may transmit the generated indicator data to POS terminal 112 for storing in a corresponding tangible, non-transitory memory. In other aspects, transaction system 130 may transmit the generated indicator data to the payment-service application executed by client device 102 (e.g., through a corresponding programmatic interface), which may incorporate the generated indicator data into the payment data transmitted to POS terminal 112. Further, in additional aspects, transaction system 130 may transmit the generated indicator data to a computer system maintained by an issuer of the physical transaction card, which may incorporate the generated indicator data into the data encoded onto the magnetic stripe, IC chip, or EMV chip, and which POS terminal 112 may receive using any of the processes described above.

Referring back to FIG. 3, if POS terminal 112 were unable to detect the generated indicator data associated with user 101 (e.g., step 310; NO), POS terminal 112 may establish that user 101 elected not to participate in the real-time transaction approval processes performed by transaction system 130, and in step 312, POS terminal 112 may route the generated transaction request to one or more computing systems associated with an existing payment network for approval and settlement (e.g., a “payment rail” associated with a fiat currency, such as Visa™, Mastercard™, American Express™, and/or Discover™ payment networks, and/or a payment rail associated with a digital or crypto-currency, such as a Bitcoin™ rail). In some aspects, and in response to the routed transaction request, POS terminal 112 may receive a confirmation of the approved and settled transaction from the one or more payment-network computing systems, which POS terminal may present to user 101 through the corresponding interface module (e.g., in step 314). Exemplary process 300 is then complete in step 316.

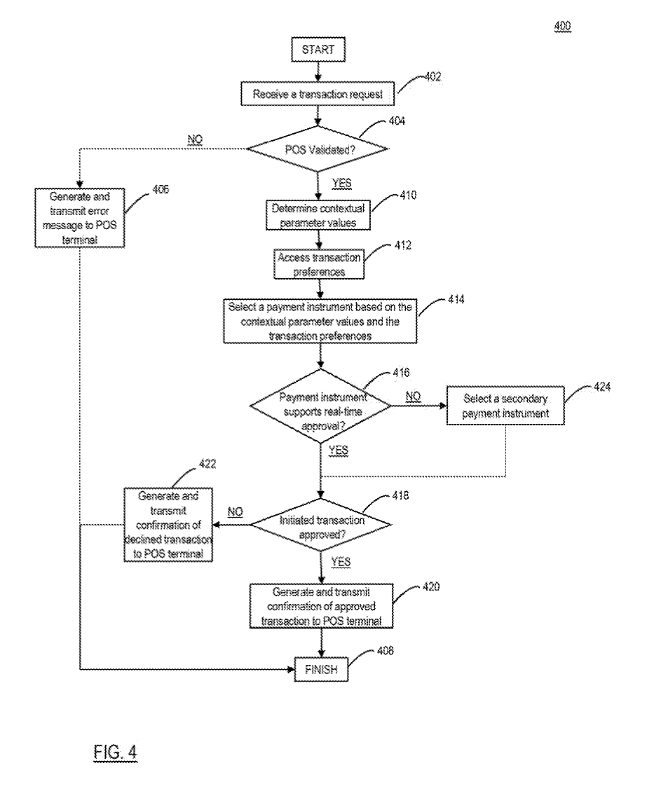

Alternatively if POS terminal 112 were to detect the generated indicator data associated with user 101 (e.g., step 310; YES), POS terminal 112 may establish that user 101 elected to participate in the real-time transaction approval processes performed by transaction system 130, POS terminal 112 may route the generated transaction request to transaction system 130 (e.g., in step 318). As described below in reference to FIG. 4, transaction system 130 may perform operations that approve the initiated transaction in real-time and prior to the settlement of the initiated transaction using a payment instrument selected on the basis of a determined transaction context and one or more user-specified transaction preferences.

FIG. 4 is a flowchart of an example process 400 for automatically approving an initiated data exchange in real-time and prior to execution, in accordance with the disclosed embodiments. In some aspects, a computing system associated with one or more POS terminal devices, such as transaction system 130, may perform the steps of example process 400. Transaction system 130 may be associated with or may administer a POS terminal or device, such as POS terminal 112 of FIG. 1, and in some instances, may receive a request, from POS terminal 112, for an approval of a transaction initiated at POS terminal 112 (e.g., a transaction request) in real-time and prior to settlement processing. In certain aspects, and in response to the received transaction request, transaction system 130 may validate an identity of POS terminal 112, establish values of contextual parameters that determine a context of the initiated transaction, select a payment instrument for use in the initiated payment transaction based on the determined transaction context and one or more user-specified transaction preferences, and perform operations that approve the initiated transaction in real-time and prior to a settlement of the initiated transaction.

Referring to FIG. 4, transaction system 130 may receive a transaction request from POS terminal 112 across a communications network, such as network 120 (e.g., in step 402). As described above, the received transaction request may include, but is not limited to transaction data characterizing the initiated transaction (e.g., identifiers of a corresponding merchant (such as merchant 111), an identifier of a product or service subject to the initiated transaction, and one or more parameters of the initiated transaction, such as a transaction amount or a transaction date and time), payment data associated with a provided form of payment (e.g., a digital wallet token or a digital wallet address, and payment instrument data that corresponds to provided form of payment, such as an account number, expiration date, card-security code (CSC), issuer identifier number (IIN), accountholder name, etc.), and cryptographic data that uniquely identifies POS terminal 112, such as a POS cryptogram generated by and assigned to POS terminal 112.

In some aspects, transaction system 130 may parse the transaction request to extract the cryptographic data, e.g., the POS cryptogram, and may validate an identity of POS terminal 112 based on a comparison of the extracted cryptographic data against locally stored cryptographic data that uniquely identifies POS terminal 112, e.g., a locally stored POS cryptogram (e.g., in step 404). For example, if transaction system 130 were to determine that the extracted POS cryptogram fails to correspond to the locally stored POS cryptogram, transaction system 130 may elect not to validate the identity of POS terminal 112 (e.g., step 404; NO), and may generate and transmit an error message to POS terminal 112 using any of the processes described herein (e.g., in step 406). Exemplary process 400 may then be complete in step 408.

If, however, transaction system 130 were to determine that the extracted POS cryptogram corresponds to the locally stored POS cryptogram, transaction system 130 may validate the identity of POS terminal 112 (e.g., step 404; YES), and based on portions of the received transaction request, transaction system 130 may determine values of one or more contextual parameters of the initiated transaction (e.g., in step 410). For example, and as described above, contextual parameters consistent with the disclosed embodiments may include, but are not limited to, or more characteristics of the product or service involved in the initiated transaction (e.g., a manufacturer or model number of the product or service), a name or location of a merchant involved in the initiated transaction (e.g., a name of merchant 111 and/or merchant 111's location), and one or more of the transaction parameters (e.g., a date and time of the initiated transaction or a transaction amount). The disclosed embodiments are, however, not limited to these examples of contextual parameters, and in additional aspects, transaction system 130 may establish values for any additional or alternate contextual parameter that characterize the initiated transaction and, when taken collectively, establish the context of the initiated transaction.

By way of example, and as described above, the initiated transaction may correspond to a purchase of a new tennis racket (e.g., a model Ti.S6 tennis racket manufactured by Head BV) in the amount of $100 from a membership-based warehouse club (e.g., Costco™) located in Arlington, Va., on Jan. 15, 2016, at 3:45 p.m. In some instances, and based on portions of the received transaction request, transaction system 130 determine values of contextual parameters of the initiated transaction that include, but are not limited to, a product type (e.g., the tennis racket), a product model (e.g., the Ti.S6 model), a product manufacturer (e.g., Head BV), a transaction amount (e.g., $100), and transaction date and time (e.g., Jan. 15, 2016, at 3:45 p.m.), a merchant type (e.g., a warehouse club), a merchant name (e.g., Costco™), and a merchant location (e.g., Arlington, Va.). When taken collectively, the determined values of the contextual parameters may establish a context of the initiated transaction, and as described herein, the one or more transaction preferences specified by user 101 may correlate specific payment instruments, rewards-program accounts, and/or loyalty-program accounts with user-specified combinations of the contextual parameters and corresponding user-specified parameter values.

In certain aspects, transaction system 130 may access locally stored data that identifies one or more transaction preferences specified by user 101 (e.g., in step 412). As described above, the one or more transaction preferences may correlate certain payment instruments, loyalty-program accounts, and rewards-program accounts held by user 101 with corresponding combinations of user-specified contextual parameter values, which may characterize corresponding transactions in which user 101 intends or prefers to use the certain payment instruments, loyalty-program accounts, and rewards-program accounts.

By way of example, and as described above, user 101 may hold payment instruments that include, but are not limited to, a MasterCard™ credit card, a Visa™ debit card, a checking account and a line-of-credit held at a financial institution, and a an account that holds units of a digital currency, such as Bitcoin™ or Litecoin™. Additionally, user 101 may also hold a rewards-program account that accrues points redeemable at one or more partner merchants (e.g., a Plenti™ account), and a loyalty-program account associated with the membership-based warehouse club (e.g., Costco™). In some instances, the accessed data may identify, for one or more of the available payment instruments, loyalty-program accounts, and rewards-program accounts, corresponding combinations of contextual parameter values that characterize transactions in which user 101 intends or prefers to use these payment instruments, loyalty-program accounts, and rewards-program accounts.

For instance, and as described above, the accessed transaction preference data may specify the digital-currency account (e.g., holding units of Bitcoin™) be used for any purchase transaction involving the membership-based warehouse club and characterized by a transaction amount in excess of $50, and for any purchase transaction characterized by a transaction amount in excess of $1,000, and that the loyalty-program account be used in conjunction with any payment instrument for purchase transaction involving the membership-based warehouse club. The disclosed embodiments are, however, not limited to these examples of transaction preferences, and in further aspects, the accessed preference data may correlate any available payment instrument, rewards-program account, or loyalty-program account to any additional or alternate combination of contextual parameter values that would be appropriate to the payment instruments, rewards-program accounts, and/or loyalty-program accounts, and to the initiated transaction.

Transaction system 130 may, in certain aspects, select one of the payment instruments that is held by user 101 and available for use in the initiated transaction, and further is associated with transaction preferences consistent with the determined context of the initiated transaction (e.g., in step 414). For example, and as described above, the context of the initiated transaction may be established by contextual parameter values that include, but are not limited to, a product type (e.g., the tennis racket), a transaction amount (e.g., $100), a transaction date and time (e.g., Jan. 15, 2016, at 3:45 p.m.), and a merchant type (e.g., a warehouse club). Based on a comparison of portions of the accessed preference data and the contextual parameter values that characterize the initiated transaction, transaction system 130 may select the digital-currency account held by user 101 as the payment instrument for the initiated transaction involving the Head™ tennis racket, the transaction amount of $100, and the membership-based warehouse club, and may further determine that the loyalty-program account should be using in conjunction with the digital-currency account when settling the initiated transaction.

Further, transaction system 130 may establish whether the selected payment instrument supports real-time approval processing (e.g., in step 416). For example, as a publicly accessible and peer-validated block-chain ledger data structure tracks the units of digital currency held by user 101 and available for transfer to other parties (e.g., which represents the current balance of the digital-currency account), transaction system 130 may establish that the digital-currency account held by user 101 supports real-time approval of the initiated transaction. Alternatively, a credit or debit card may not support the real-time approval for use in the initiated payment transaction, as such a decision may require communication between transaction system 130 and one or more payment rails (e.g., a computing system maintained by a Visa™ payment network) of computing systems maintained by corresponding issuers.

If transaction system 130 were to establish that the selected payment instrument supports real-time approval processing (e.g., step 416; YES), transaction system 130 may perform any of the processes described above to approve the use of the selected payment instrument (e.g., the digital-currency account held by user 101) for use in the initiated transaction, and thus, approve the initiated transaction (e.g., in step 418). For example, and as described above, transaction system 130 may access stored data establishing a shadow digital-currency account maintained on behalf of user 101 by transaction system 130, may determine a current account balance of the shadow digital-currency account (e.g., a number of units of digital currency held by user 101), and validate the availability of the selected digital-currency account for use in the initiated transaction based on comparison of the current account balance and the transaction amount.

If transaction system 130 were to determine the current account balance exceeds the transaction amount, transaction system 130 may approve the use of the selected payment instrument in the initiated transaction, and thus approve the initiated transaction in real-time (e.g., step 418; YES). In some aspects, transaction system 130 may generate a message confirming the approved transaction, and may transmit the generated message to POS terminal 112 for presentation to user 101 (e.g., in step 420). Exemplary process 400 may then be complete in step 408.

Alternatively, if transaction system 130 were to determine the current account balance fails to exceed the transaction amount, transaction system 130 decline the use of the selected payment instrument in the initiated transaction, and thus decline the initiated transaction in real-time (e.g., step 418; NO). In some aspects, transaction system 130 may generate a message confirming the declined transaction, and may transmit the generated message to POS terminal 112 for presentation to user 101 (e.g., in step 422). Exemplary process 400 may then be complete in step 408.

Referring back to step 416, if transaction system 130 were to establish that the selected payment instrument (e.g., a “primary” payment instrument) does not support real-time approval processing (e.g., step 416; NO), transaction system 130 may perform any of the processes described above to select a secondary payment instrument held by user 101, suitable for use in the initiated transaction, and supportive of real-time approval processing (e.g., in step 424). For example, the primary payment instrument may correspond to a MasterCard™ credit card held by user 101, which may not support real-time approval processing due to the necessary data exchanges between transaction system 130, and in some instances, transaction system 130 may establish user 101's digital-currency account, which support real-time approval processing, as the secondary payment account.

In one aspect, and upon selection of the secondary payment account, exemplary process 400 may pass forward to step 418, and transaction system 130 may perform any of the processes described above to approve the use of the secondary payment instrument (e.g., the digital-currency account held by user 101) for use in the initiated transaction, and thus, approve the initiated transaction. Further, and as described above, transaction system 130 may perform operations that secure a portion of held units of digital currency correspond to the transaction amount of the initiated transaction, which may be released or reversed in response to a successful settlement of the initiated transaction involving the primary payment instrument, e.g., the MasterCard™ credit card. Alternatively, and in response to an unsuccessful settlement using the primary payment instrument, transaction system 130 may perform any of the exemplary processes described above to settle the initiated transaction using the secondary payment instrument, e.g., the digital-currency account held by user 101.

Referring back to FIG. 3, POS terminal 112 may receive the message from transaction system 130, which may confirm the real-time decision by transaction system 130 to decline or approve the initiated transaction (e.g., in step 320). In certain aspects, POS system 112 may generate one or more interface elements that provide a graphical representation of the real-time decision to approve or decline the initiated transaction, which may be presented to user 101 through a corresponding interface module, such as the pressure-sensitive, touchscreen display (e.g., in step 320). Exemplary process 300 is then complete in step 316.

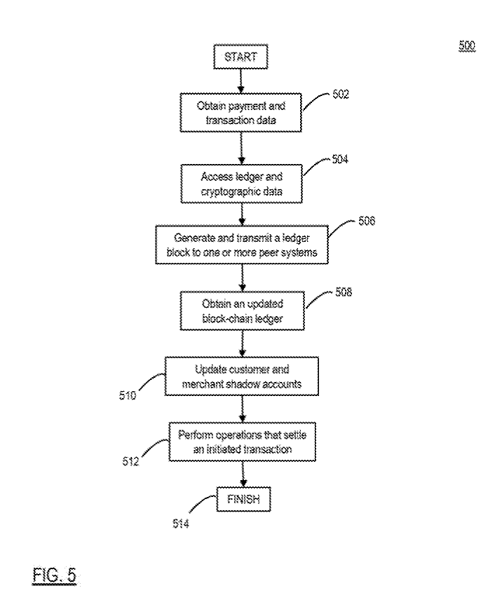

FIG. 5 is a flowchart of an example process 500 for automatically executing an approved data exchange, in accordance with the disclosed embodiments. In some aspects, a computing system associated with one or more POS terminal devices, such as transaction system 130 of FIG. 1, may perform the steps of example process 500. For example, transaction system 130 may receive payment data identifying a payment instrument selected based on a determined transaction context and one or more user-specified transaction preferences, and transaction data identifying one or more parameters of an approved transaction, such as a transaction amount. In one aspect, and consistent with the disclosed embodiments, exemplary process 500 may perform operations that settle the approved transaction in accordance with the identified transaction parameters and using an account of a customer, e.g., user 101 of FIG. 1, holding units of a digital currency tracked within one or more block-chain ledgers.

Transaction system 130 may receive payment data identifying a payment instrument selected based on a determined transaction context and one or more user-specified transaction preferences, and transaction data identifying one or more parameters of an approved transaction, such as a transaction amount (e.g., in step 502). In some instances, the payment data may identify an account of user 101 that holds one or more units a digital currency, such as Bitcoin™, and may include an identifier of a digital wallet that maintains user 101's digital-currency account (e.g., as established by a payment-service application executed by claim device).

Based on portions of the received payment data, transaction system 130 may access stored ledger data corresponding to a current block-chain ledger that tracks the units of digital currency held by user 101, and further, cryptographic data includes, among other things, a private cryptographic key of user 101 and a public cryptographic key of a merchant involved in the initiated transaction, e.g., merchant 111 (e.g., in step 504). In certain aspects, and based on portions of the payment data, the ledger data, and the cryptographic data, transaction system 130 may perform any of the exemplary processes described above to generate a ledger block corresponding to the approved transaction involving the digital-currency account of user 101 and transmit that ledger block to one or more of peer systems 160 for processing, validation, and inclusion within an updated block-chain ledger (e.g., in step 506). As described below, the generated ledger block, when included within the updated block-chain ledger, may facilitate a transfer of units of digital currency corresponding to the transaction amount from the digital-currency account held by user 101 to a corresponding account held by merchant 111.

As described above, the one or more of peer systems 140 may receive the ledger block from transaction system 130. In certain aspects, the one or more of peer systems 140 may act as “miners” for the block-chain ledger, and may competitively process the ledger block (either alone or in conjunction with other data) to generate a new block for the block-chain ledger that reflects a transfer of the units of digital currency consistent with the transaction amount from the digital-currency account of user 101 to the digital-currency account of merchant 111. The one or more of peer systems 140 may append the new block to the current block-chain ledger to establish an updated block-chain ledger, which may be distributed across peer systems 140 (e.g., through a peer-to-peer network) and to other network-connected devices operating within environment 100, such as transaction system 130. In step 508, transaction system 130 may receive data corresponding to the updated block-chain ledger from the one or more of peer systems 140, and as described above, the updated block-chain ledger may facilitate the transfer of the units of digital currency consistent with the transaction amount between accounts of user 101 and merchant 111.

In further aspects, transaction system 130 may perform any of the processes described above to update shadow digital-currency accounts of user 101 and merchant 111 (e.g., as maintained by transaction system 130 on behalf of user 101 and merchant 111) to reflect the transfer of the units of digital currency consistent with the transaction amount from the digital-currency account of user 101 to the digital-currency account of merchant 111 (e.g., in step 510). In certain embodiments, by modifying balances of shadow accounts representative of the units of digital currency held within digital-currency accounts of user 101 and merchant 111, transaction system 130 may track internally the impact of the purchase transaction on the digital-currency accounts of user 101 and merchant 111 prior to, and independent of, settlement processing, which may provide an independent mechanism for auditing and reconciling an outcome of the settlement processing on the digital-currency accounts of user 101 and merchant 111.

Further, transaction system 130 may perform any of the processes described above to process and settle the initiated transaction in accordance with the selected payment instrument (e.g., the digital-currency account held by user 101), one or more selected rewards-program accounts or loyalty-program accounts (e.g., the loyalty-program account associated with the membership-based warehouse club, as described above), and the transaction parameters of the initiated transaction (e.g., in step 512). For example, transaction system 130 may exchange data with one or more third-party computing systems (e.g., third-party computing systems 150) maintained by the membership-based warehouse club or any additional or alternate provider of the loyalty-program account), and the one or more third-party computing systems may perform operations that credit the loyalty-program account held by user 101 in accordance with the transaction amount of the purchase from the membership-based warehouse club. Upon successful settlement of the initiated payment transaction, settlement module 245 may generate data indicative of the settlement, e.g., settlement data 246, which may be stored within one or more tangible, non-transitory memories, such as data repository 134. Exemplary process 500 may then be complete in step 514.

### III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification, including mobile wallet module 202, transaction initiation module 212, routing module 217, transaction confirmation module 218, POS validation module 230, payment selection module 232. transaction validation module 234, transaction module 238, and settlement module 245, can be implemented as one or more computer programs, i.e., one or more modules of computer program instructions encoded on a tangible non-transitory program carrier for execution by, or to control the operation of, a data processing apparatus (or a computer system). Additionally or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “apparatus” refers to data processing hardware and encompasses all kinds of apparatus, devices, and machines for processing data, including by way of example a programmable processor, a computer, or multiple processors or computers. The apparatus can also be or further include special purpose logic circuitry, such as an FPGA (field programmable gate array) or an ASIC (application-specific integrated circuit). The apparatus can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a storage unit storing instructions;
a communications module; and
at least one processor coupled to the communications module and the storage unit, the at least one processor being configured to execute the instructions to:
receive, through the communications module, data from a terminal device, the data being associated with a data exchange initiated at the terminal device, the data comprising a parameter that characterizes the data exchange;
identify a data type based on the received data;
access data corresponding to a block-chain ledger, the block-chain ledger tracking prior data exchanges involving the identified data type;
determine, based on the accessed data, an availability of the identified data type for use in the data exchange;
transmit via the communications module to the terminal device, in response to the determination, a message confirming the availability of the identified data type; and
perform the data exchange in accordance with the parameter and using the identified data type,
wherein the message is transmitted to the terminal device prior to the completion of the data exchange.

2. The apparatus of claim 1, wherein:
the received data comprises first cryptographic data associated with the terminal device; and
the at least one processor is further configured to execute the instructions to:
obtain second cryptographic data associated with the terminal device;
determine that second cryptographic data corresponds to the first cryptographic data; and
validate an identity of the terminal device in response to the determination that the second cryptographic data corresponds to the first cryptographic data.

3. The apparatus of claim 1, wherein the at least one processor is further configured to execute the instructions to:
identify candidate data types associated with the received data;
obtain data identifying preferences that associate the candidate payment instruments with specified parameters;
establish that the parameter of the initiated data exchange is consistent with the specified parameter of a corresponding one of the preferences;
identify the candidate data type associated with the corresponding one of the preferences; and
establish the candidate data type the identified data type.

4. The apparatus of claim 1, wherein:
the data exchange corresponds to a transaction initiated at the terminal device; and
the received data further comprises a transaction parameter that characterizes the initiated transaction.

5. The apparatus of claim 4, wherein:
the data type corresponds to a first payment instrument; and
the at least one processor is further configured to execute the instructions to:
determine, based on the accessed data, an availability of the first payment instrument for use in the transaction;
transmit to the terminal device, in response to the determination, a message confirming the availability of the first payment instrument; and
settle the transaction in accordance with the transaction parameter and using the first payment instrument,
wherein the message is transmitted to the terminal device prior to the settlement of the transaction.

6. The apparatus of claim 5, wherein the at least one processor is further configured to execute the instructions to:
identify candidate payment instruments available for use in the transaction;
obtain data identifying transaction preferences, each transaction preference associating one of the candidate payment instruments with a specified transaction parameter;
establish that the transaction parameter of the initiated transaction is consistent with the specified transaction parameter of a corresponding one of the transaction preferences;
identify the candidate payment instrument associated with the corresponding one of the transaction preferences; and
establish the identified candidate payment instrument the first payment instrument.

7. The apparatus of claim 6, wherein the at least one processor is further configured to execute the instructions to receive, through the communications module, a portion of the data identifying the transaction preferences from the terminal device.

8. The apparatus of claim 5, wherein:
the transaction parameter comprises a transaction amount;
the first payment instrument comprises a first account holding units of a digital currency; and
the block-chain ledger tracks prior transactions involving the units of the digital currency.

9. The apparatus of claim 8, wherein the at least one processor is further configured to execute the instructions to:
based on the accessed data, establish a balance of the units of the digital currency held by the first account;
determine that the established balance exceeds the transaction amount; and
in response to the determination that the established balance exceeds the transaction amount, establish the availability of the first payment instrument for use in the transaction.

10. The apparatus of claim 9, wherein the at least one processor is further configured to execute the instructions to:
generate first data associated a first shadow account, the first shadow account being representative of the first account that holds the units of the digital currency, and the generated first data reflecting the established balance of the units of the digital currency; and
generate ledger data specifying a transfer of a portion of the units of the digital currency from the first account to a second account, the transferred portion being consistent with the transaction amount.

11. The apparatus of claim 10, wherein the at least one processor is further configured to execute the instructions to:
transmit, through the communications module, the generated ledger data to a computing system, the computing system being configured to generate an updated block-chain ledger that includes the generated ledger data;
receive, through the communications module, data corresponding to the updated block-chain ledger from the computing system; and
in response to the received data, perform operations that settle the transaction in accordance with the transaction parameter.

12. The apparatus of claim 10, wherein the at least one processor is further configured to execute the instructions to:
modify the first data to reflect the transfer of the portion of the units of the digital currency from the first account; and
generate second data associated with a second shadow account, the second shadow account being representative of the second account that receives the transferred portion of the units of the digital currency from the first account, and the generated second data reflecting a balance of the units of the digital currency held by the second account.

13. The apparatus of claim 5, wherein:
the received data comprises payment data identifying the first payment instrument, the payment data comprising cryptographic data identifying the first payment instrument or a token associated with an application executed by the terminal device; and
the at least one processor is further configured to execute the instructions to:
identify a reward-program account or a loyalty-program account based on the payment data; and
perform operations that settle the transaction in accordance with the transaction parameter and using the identified payment instrument and the reward-program account or the loyalty-program account.

14. A terminal device, comprising:
a storage unit storing instructions;
a communications module;
an interface module; and
at least one processor coupled to the communications module, the interface module, and the storage unit, the at least one processor being configured to execute the instructions to:
receive, through the interface module, parameter data characterizing an exchange of data initiated at the terminal device;
identify a destination computing system based on properties of the initiated data exchange, the destination computing system being configured to determine an availability of a data type for use in completing the initiated data exchange based on data corresponding to a block-chain ledger, the block-chain ledger tracking prior data exchanges involving the data type;
transmit, through the communications module, the obtained parameter data to the destination computing system;
receive, from the destination computing system and through the communications module, a message confirming an availability of the data type for use in completing the initiated data exchange, the message being received prior to a completion of the initiated data exchange by the destination computing system; and
display, through the interface module, interface elements representative of the received message.

15. The terminal device of claim 14, wherein:
the data exchange corresponds to a transaction;
the parameter data comprises a transaction parameter that characterizes the initiated transaction;
the data type corresponds to a first payment instrument;
the completion of the initiated transaction corresponds to a settlement of the initiated transaction by the destination computing system; and
the received message confirms an approval of the first payment instrument for use in the initiated transaction prior to the settlement.

16. The terminal device of claim 15, wherein:
the terminal device further comprises a scanning module, the scanning module being configured to request payment data from a tangible, non-transitory computer-readable storage medium; and
the at least one processor of the apparatus is further configured to execute the instructions to:
receive, from the scanning module, payment data encoded onto the tangible, non-transitory computer-readable storage medium; and
transmit, through the communications module, the obtained parameter data and the received payment data to the destination computing system.

17. The terminal device of claim 15, wherein the at least one processor of the apparatus is further configured to execute the instructions to:
receive, through the communications module, payment data from a device, the device being configured to execute an application that generates the payment data; and
transmit, through the communications module, the obtained parameter data and the received payment data to the destination computing system.

18. The terminal device of claim 15, wherein the at least one processor of the apparatus is further configured to execute the instructions to:
determine an eligibility of the initiated transaction for approval prior to settlement based on the properties of the initiated transaction;
identify candidate destination computing systems, the candidate destination computing systems comprising a first candidate computing system configured to approve the initiated transaction for approval prior to settlement and a second candidate computing system associated with a payment network; and
in response to the determined eligibility, establish the first candidate computing system as the destination computing system.

19. A system, comprising:
a terminal device; and
an apparatus communicable with the terminal device across a communications network,
wherein the apparatus comprises:
a storage unit storing instructions;
a communications module; and
at least one processor coupled to the communications module and the storage unit, the at least one processor being configured to execute the instructions to:
receive, through the communications module, data from the terminal device, the data being associated with a data exchange initiated at the terminal device, the data comprising a parameter that characterizes the data exchange;
identify a data type based on the received data;
access data corresponding to a block-chain ledger, the block-chain ledger tracking prior data exchanges involving the identified data type;
determine, based on the accessed data, an availability of the identified data type for use in the data exchange;
transmit via the communications module to the terminal device, in response to the determination, a message confirming the availability of the identified data type; and
perform the data exchange in accordance with the data exchange parameter and using the identified data type,
wherein the message is transmitted to the terminal device prior to the completion of the data exchange.

20. The system of claim 19, wherein:
the transaction corresponds to a purchase of a good or service;
the parameter comprises a transaction amount;
the data type corresponds to a payment instrument, the payment instrument comprising an account that holds units of a digital currency; and
the at least one processor of the apparatus is further configured to execute the instructions to:
determine, based on the accessed data, an availability of the payment instrument for use in the transaction;
transmit to the terminal device in response to the determination, a message confirming the availability of the first payment instrument; and
settle the transaction in accordance with the transaction parameter and using the first payment instrument,
wherein the message is transmitted to the terminal device prior to the settlement of the transaction.
